(19) United States
(12) Patent Application Publication
(10) Pub. No.: US 2026/0326312 A1
(43) Pub. Date: Oct. 22, 2026

(54) END EFFECTOR HAVING MULTIPLE FINGERS FOR ROBOTIC SYSTEMS

(71) Applicant: The Regents of the University of California, Oakland, CA (US)

(72) Inventors: Iman Soltani Bozchalooi, Sacramento, CA (US); Al Arsh Basheer, Pleasanton, CA (US)

(21) Appl. No.: 19/572,628

(22) Filed: Mar. 19, 2026

Related U.S. Application Data
(60) Provisional application No. 63/790,243, filed on Apr. 17, 2025.

(51) Int. Cl. B25J 15/00; B25J 15/02

(52) U.S. Cl. CPC B25J 15/0009; B25J 15/0213

(57) ABSTRACT

An end effector having multiple fingers for robotic systems is provided. In some embodiments, a robotic end effector apparatus is provided that includes: a palm assembly having five fingers, where each finger has a plurality of phalangeal joint assemblies and a plurality of phalangeal cavities, where each phalangeal joint assembly is independently controlled using a linear actuator assembly that is actuated by a motor, and where the motor in the linear actuator assembly for each phalangeal joint assembly is positioned within one of the plurality of phalangeal cavities. In some embodiments, each phalangeal joint assembly is configured to be self-locking by selecting a friction angle between a resultant friction force and a normal force between an output shaft of the motor in the linear actuator assembly and a component in the linear actuator assembly that is positioned at an end of the output shaft to be greater than a lead angle of the output shaft of the motor in the linear actuator assembly. In some embodiments, the robotic end effector apparatus further includes a wrist assembly that includes a lower wrist platform that is connected to a robotic system, an upper wrist platform that is connected to the palm assembly, a plurality of linear actuators that are each connected to the lower wrist platform and the upper wrist platform, and a universal wrist joint that links the lower wrist platform and the upper wrist platform and that is positioned between the plurality of linear actuators.

### CROSS-REFERENCE TO RELATED APPLICATIONS

This application claims the benefit of U.S. Provisional Patent Application No. 63/790,243, filed Apr. 17, 2025, which is hereby incorporated by reference herein in its entirety.

### TECHNICAL FIELD

The disclosed subject matter relates to an end effector having multiple fingers for robotic systems. More particularly, the disclosed subject matter relates to a lightweight, high degree-of-freedom robotic end effector that can include (i) a palm module having multiple fingers that each include multiple phalangeal cavities and (ii) a wrist module, where each finger in the robotic end effector has multiple phalangeal joint assemblies and where each phalangeal joint assembly can be independently controlled using a linear actuator assembly that is actuated by a motor and where the motor in the linear actuator assembly for each phalangeal joint assembly is positioned within one of the phalangeal cavities.

### BACKGROUND

Automation has revolutionized industries by enhancing efficiency, reducing costs, and increasing production flexibility. However, due to software complexity, hardware constraints, and limited adaptability, assembly floors have been one of the last beneficiaries of automation. The technological lag in assembly automation stems primarily from the technical complexity of even the simplest tasks, such as threading a wire through a hole or connecting an electrical plug, let alone assembling intricate parts. Such tasks often rely on a complex combination of human dexterity and the ability to process various sensory inputs including tactile, visual, and/or auditory feedback. Many industrial robotic grippers, for example, are designed primarily for repetitive and simple tasks, such as pick-and-place operations with limited object manipulation capabilities, thereby making them unsuitable for assembly or other more complex tasks encountered on assembly floors. With current two-finger or three-finger grippers, adapting to new tasks remains challenging, requiring new research and development for each new automation task. This further limits the advancement in automation by making it economically unjustifiable, especially when dealing with small batches of products or custom products. As such, despite the common misconception of extensive automation of assembly activities in large industries, such as the automotive industry, most of these tasks continue to be manually executed by humans.

There is, therefore, a pressing need for robotic hands that meet the requirements of dexterous manipulation. Such a robotic hand should be lightweight to ensure compatibility with a wide range of robotic arms without significantly reducing their payload capacity. Moreover, such a robotic hand should offer sufficient degrees of freedom to perform complex tasks while handling large payloads, which is often encountered on assembly floors. Furthermore, since production parts are typically designed with the dexterity capabilities of human workers in mind, such a robotic hand should incorporate anthropomorphic features to maximize their effectiveness.

Integrating these requirements into a single robotic hand, however, presents a significant challenge. While various robotic end effectors have been developed and particularly optimized for specific applications, their widespread adoption in the automation industry and other industries for dexterous manipulation remains limited due to, for example, limited degrees of freedom, severe under-actuation, overly complex designs (e.g., tendon-driven end effectors that require tedious tendon routing), and/or excessive weight (e.g., which confines their use to high payload industrial or collaborative robots), etc. It should be noted that a heavy robotic end effector reduces the effective payload capacity of the robot hand system.

Accordingly, it is desirable to provide methods, systems, and media that overcome these and other deficiencies in the prior art. For example, an improved robotic end effector having multiple fingers is provided.

### SUMMARY

A robotic end effector having multiple fingers is provided.

In accordance with some embodiments of the disclosed subject matter, a robotic end effector apparatus is provided, the robotic end effector apparatus comprising: a palm assembly having five fingers, where each finger has a plurality of phalangeal joint assemblies and a plurality of phalangeal cavities, where each phalangeal joint assembly is independently controlled using a linear actuator assembly that is actuated by a motor, and where the motor in the linear actuator assembly for each phalangeal joint assembly is positioned within one of the plurality of phalangeal cavities.

In some embodiments, the linear actuator assembly includes a leadscrew nut that traverses a leadscrew actuated by the motor, where the leadscrew is connected to the motor at an end of the leadscrew and where the leadscrew nut is connected to the leadscrew at an opposing end of the leadscrew.

In some embodiments, at least one of the five fingers includes three phalangeal joint assemblies, where each of the three phalangeal joint assemblies is one of a distal interphalangeal joint assembly, a proximal interphalangeal joint assembly, and a metacarpophalangeal joint assembly.

In some embodiments, a first length of the leadscrew in the linear actuator assembly corresponding to at least one of the distal interphalangeal joint assembly and the proximal interphalangeal joint assembly is different than a second length of the leadscrew in the linear actuator assembly corresponding to the metacarpophalangeal joint assembly.

In some embodiments, the leadscrew nut connects the linear actuator assembly corresponding to a phalangeal joint assembly to a finger phalange, where rotation of the leadscrew by the motor in the linear actuator assembly causes an axial force on the leadscrew nut, and where the axial force on the leadscrew nut generates a torque around the phalangeal joint assembly.

In some embodiments, a friction angle between a resultant friction force and a normal force between the leadscrew and the leadscrew nut in the linear actuator assembly is configured to be greater than a lead angle of the leadscrew in the linear actuator assembly.

In some embodiments, at least one of the five fingers includes two phalangeal joint assemblies and each of the two phalangeal joint assemblies is one of an interphalangeal joint assembly and a metacarpophalangeal joint assembly.

In some embodiments, at least one of the five fingers includes a thumb, where the thumb includes the linear actuator assembly for each of the interphalangeal joint assembly and the metacarpophalangeal joint assembly and where the thumb includes a carpometacarpal joint assembly that comprises: (i) a thumb motor positioned within a palm cavity of the palm assembly; and (ii) a driver worm that is connected to the thumb motor and a worm wheel, where rotation of the driver worm by the thumb motor causes the worm wheel to rotate and actuate the carpometacarpal joint assembly.

In some embodiments, the carpometacarpal joint assembly further comprises a ball bearing that secures the driver worm to an inner wall portion of the palm cavity.

In some embodiments, at least one of the five fingers includes a thumb, where the thumb includes the linear actuator assembly for each of the interphalangeal joint assembly and the metacarpophalangeal joint assembly, and where the thumb includes a carpometacarpal joint assembly that comprises: a flexion-extension motor positioned within a palm cavity of the palm assembly; and a driver worm that is connected to the flexion-extension motor and a worm wheel, where rotation of the driver worm by the thumb motor causes the worm wheel to rotate and actuate the carpometacarpal joint assembly to provide movement toward and away from the palm assembly.

In some embodiments, at least one of the five fingers includes a thumb, where the thumb includes the linear actuator assembly for each of the interphalangeal joint assembly and the metacarpophalangeal joint assembly, and where the thumb includes a carpometacarpal joint assembly that comprises: an abduction-adduction motor positioned within a palm cavity of the palm assembly that drives one or more spur gears, where rotation of the one or more spur gears actuates the carpometacarpal joint assembly to provide motion out of a hand plane.

In some embodiments, the robotic end effector apparatus further comprises: (i) a servo motor that is connected to a pinion gear; (ii) a hybrid transmission shaft that includes a bevel gear portion and a plurality of worm portions, where the pinion gear is configured to interact with the bevel gear portion on the hybrid transmission shaft; and (iii) a worm gear positioned at a base of a finger, where the worm gear is configured to interact with one of the plurality of worm portions on the hybrid transmission shaft.

In some embodiments, a first portion of the plurality of worm portions on the hybrid transmission shaft has a different orientation than a second portion of the plurality of worm portions on the hybrid transmission shaft.

In some embodiments, the servo motor is configured to drive the plurality of worm portions on the hybrid transmission shaft, where the plurality of worm portions on the hybrid transmission shaft interact with a plurality of worm gears located at the base of a subset of the five fingers in the palm assembly.

In some embodiments, the robotic end effector apparatus further comprises a plurality of servo motors that are each connected to a worm gear located at the base of each of the five fingers in the palm assembly.

In some embodiments, the robotic end effector apparatus further comprises: (i) a plurality of servo motors that are each connected to a pinion gear; (ii) a plurality of hybrid transmission shafts that each includes a bevel gear portion and a worm portion, where the pinion gear connected to one of the plurality of servo motors is configured to interact with the bevel gear portion on one of the plurality of hybrid transmission shafts; and (iii) a worm gear positioned at a base of a finger is independently controlled by one of the plurality of servo motors, where the worm gear is configured to interact with the worm portion on one of the plurality of hybrid transmission shafts.

In some embodiments, the robotic end effector apparatus further comprises a wrist assembly having a lower wrist platform that is connected to a robotic system and an upper wrist platform that is connected to the palm assembly.

In some embodiments, the wrist assembly comprises a plurality of linear actuators that are each connected to the lower wrist platform and the upper wrist platform.

In some embodiments, each of the plurality of linear actuators is connected to a plurality of connection points on one of the lower wrist platform and the upper wrist platform using a plurality of spherical joints.

In some embodiments, the wrist assembly comprises a ninety degree universal joint that links the lower wrist platform and the upper wrist platform and that is positioned between the plurality of linear actuators.

In some embodiments, the robotic end effector apparatus further comprises: (i) a plurality of motors that control a plurality of linear actuator assemblies that are each associated with one of the plurality of phalangeal joint assemblies; (ii) a plurality of motor controllers that each transmit power signals from a power supply to a first subset of the plurality of motors and receive encoder signals from the first subset of the plurality of motors; and (iii) a microcontroller that transmits instructions to and receives the encoder signals from a second subset of the plurality of motors.

In some embodiments, the microcontroller receives instructions from at least one of a parent controller and a computing device.

In accordance with some embodiments of the disclosed subject matter, a robotic end effector apparatus is provided, the robotic end effector apparatus comprising: a palm assembly having five fingers, where each finger has a plurality of phalangeal joint assemblies, where each phalangeal joint assembly is independently controlled using a linear actuator assembly that is actuated by a motor, and where each phalangeal joint assembly is configured to be self-locking by selecting a friction angle between a resultant friction force and a normal force between an output shaft of the motor in the linear actuator assembly and a component in the linear actuator assembly that is positioned at an end of the output shaft to be greater than a lead angle of the output shaft of the motor in the linear actuator assembly.

In accordance with some embodiments of the disclosed subject matter, a robotic end effector apparatus is provided, the robotic end effector apparatus comprising: (i) a palm assembly having five fingers, where each finger has a plurality of phalangeal joint assemblies, and where each phalangeal joint assembly is independently controlled using a linear actuator assembly that is actuated by a motor; and (ii) a wrist assembly that includes a lower wrist platform that is connected to a robotic system, an upper wrist platform that is connected to the palm assembly, a plurality of linear actuators that are each connected to the lower wrist platform and the upper wrist platform, and a universal wrist joint that links the lower wrist platform and the upper wrist platform and that is positioned between the plurality of linear actuators.

In some embodiments, the robot end effector apparatus further comprises a teleoperation system that includes a motion-capture glove worn by a user, an inertial measurement unit, and one or more inside-out positional tracking devices, wherein first motions captured by the motion-capture glove are translated to teleoperate each phalangeal joint assembly in the palm assembly of the robotic end effector apparatus, wherein second motions captured by the inertial measurement unit are translated to teleoperate the wrist assembly of the robotic end effector apparatus, and wherein third motions captured by the one or more inside-out positional tracking devices are translated to teleoperate the robotic system.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an illustrative schematic diagram of an end effector for a robotic system in accordance with some embodiments of the disclosed subject matter.

FIG. 2 shows an illustrative example of a rear view of the end effector in which the back of a palm module is shown in accordance with some embodiments of the disclosed subject matter.

FIG. 3 shows an illustrative schematic diagram of a finger assembly corresponding to one of fingers (D2-D5) of the end effector in accordance with some embodiments of the disclosed subject matter.

FIG. 4 shows an illustrative schematic diagram of a linear actuation mechanism that can include a leadscrew that is connected at an end of a motor, where the motor is connected to a lower phalange by a motor holder and where a leadscrew nut is connected to an opposing end of the leadscrew, in accordance with some embodiments of the disclosed subject matter.

FIG. 5 shows an illustrative schematic diagram showing the multiple components of the motor holder in accordance with some embodiments of the disclosed subject matter.

FIG. 6 shows an illustrative schematic diagram showing the leadscrew nut being connected to an upper phalange that allows the leadscrew nut to engage the finger and rotate relative to the finger in accordance with some embodiments of the disclosed subject matter.

FIG. 7 shows an illustrative example of the leadscrew in the linear actuation mechanism configured to control one of the phalangeal joint assemblies in one of the fingers in the palm assembly of the end effector in accordance with some embodiments of the disclosed subject matter.

FIG. 8A shows an illustrative schematic diagram of a thumb carpometacarpal joint actuation mechanism that drives a carpometacarpal joint in the thumb of the end effector in accordance with some embodiments of the disclosed subject matter.

FIGS. 8B and 8C shows an illustrative schematic diagram of an alternate thumb carpometacarpal joint actuation mechanism that drives a carpometacarpal joint in the thumb of the end effector in accordance with some embodiments of the disclosed subject matter.

FIG. 9 shows an illustrative schematic diagram of an abduction-adduction mechanism configured within a palm cavity of the end effector in accordance with some embodiments of the disclosed subject matter.

FIG. 10A shows an illustrative example of worm gears located at the finger root of particular fingers in the end effector in which an abduction movement is being performed in particular fingers of the end effector in accordance with some embodiments of the disclosed subject matter.

FIG. 10B shows an illustrative schematic diagram of an abduction-adduction mechanism configured within a palm cavity of the end effector in which multiple servo motors can be implemented to individually control each finger in the end effector in accordance with some embodiments of the disclosed subject matter.

FIG. 11 shows an illustrative schematic diagram of a wrist module of the end effector in which an upper wrist platform of the wrist module can be connected to the palm module and in which a lower wrist platform of the wrist module can be connected to a robotic system (such as a robotic arm system) is shown in accordance with some embodiments of the disclosed subject matter.

FIG. 12A shows an illustrative example of the positioning of the linear actuators in the wrist module of the end effector in accordance with some embodiments of the disclosed subject matter.

FIG. 12B shows an illustrative example of the configuration of the upper wrist platform in the wrist module in comparison with a spherical joint and a clevis pin in accordance with some embodiments of the disclosed subject matter.

FIG. 13 shows an illustrative example of an electrical system for controlling the actuation mechanisms in the end effector in accordance with some embodiments of the disclosed subject matter.

FIG. 14 is a block diagram of hardware that can be used in a computing device of FIG. 13 in accordance with some embodiments of the disclosed subject matter.

FIG. 15 shows an illustrative example of active fingertip force of a finger and its corresponding phalangeal joint assemblies that are each being independently controlled by the linear actuation mechanism configured in accordance with some embodiments of the disclosed subject matter as a function of time.

FIG. 16 shows an illustrative example of passive force capacity of the end effector configured in accordance with some embodiments of the disclosed subject matter.

FIG. 17 shows an illustrative example of the thumb dexterity and the opposability of the thumb in the palm module of the end effector configured in accordance with some embodiments of the disclosed subject matter.

FIG. 18 shows an illustrative example of the workspaces of the fingers and the thumb in the end effector configured in accordance with some embodiments of the disclosed subject matter.

FIG. 19 shows an illustrative table that compares the range of motion between the joints in the end effector configured in accordance with some embodiments of the disclosed subject matter and the joints in a human hand.

FIG. 20 shows an illustrative example of diverse and precise grasping tasks performed by the end effector configured in accordance with some embodiments of the disclosed subject matter.

FIG. 21 shows an illustrative table that compares the dimensions of the end effector configured in accordance with some embodiments of the disclosed subject matter with the dimensions of a human hand.

FIG. 22 shows an illustrative example of teleoperation using an inside-out tracking system that includes a motion-capture glove, an inertial measurement unit, and one or more motion trackers, and the end effector configured in accordance with some embodiments of the disclosed subject matter.

FIG. 23 shows an illustrative example of a process for translating movement information from the teleoperation setup that can include a motion-capture glove, an inertial measurement unit positioned on a wrist of a user wearing the motion-capture glove, and one or more motion trackers placed on a forearm of the user wearing the motion-capture glove to the end effector configured in accordance with some embodiments of the disclosed subject matter.

### DETAILED DESCRIPTION

An end effector having multiple fingers for robotic systems is provided.

In some embodiments, a lightweight, high degree-of-freedom robotic end effector having multiple fingers that each include multiple phalangeal cavities is provided, where each finger in the robotic end effector has multiple phalangeal joint assemblies, where each phalangeal joint assembly can be independently controlled using a linear actuator assembly that is actuated by a motor, and where the motor in the linear actuator assembly for each phalangeal joint assembly can be positioned within one of the phalangeal cavities (e.g., along the dorsal side of each finger).

In some embodiments, any suitable linear actuator assembly can be used to control each phalangeal joint assembly. For example, in some embodiments, the linear actuator assembly can include a leadscrew nut that traverses a leadscrew actuated by the motor. In continuing this example, the leadscrew or other suitable output shaft can extend from one end of the motor, where the leadscrew can convert the mechanical energy in the form of rotational motion generated by the motor to drive the leadscrew nut that is connected to an opposing end of the leadscrew.

In some embodiments, the linear actuator assembly used to control each phalangeal joint assembly can be positioned within a phalangeal cavity of a finger phalange. For example, the leadscrew nut can be connected to an upper phalange at a suitable pivot point (e.g., proximal to a base portion of the upper phalange) and the motor, a motor holder, or any other suitable motor support structure can be connected to a lower phalange or a portion of a palm cavity at a suitable pivot point (e.g., proximal to a base portion of the lower phalange) such that the linear actuator assembly is positioned within a phalangeal cavity of the lower phalange.

It should be noted that, as described herein, the linear actuator assemblies and its corresponding motors for controlling each phalangeal joint assembly and the other actuation mechanisms for controlling an abduction-adduction mechanism, an abduction-adduction mechanism of a thumb carpometacarpal joint assembly, a flexion-extension mechanism of the thumb carpometacarpal joint assembly, a wrist module, or any other suitable portion of the end effector can generally be housed within the end effector (which is sometimes referred to herein as the “palm cavity” of the palm module). For example, the linear actuator assemblies and its corresponding motors can be positioned within a phalangeal cavity of a finger phalange (e.g., along the dorsal side of the finger). In another example, the linear actuator assemblies and its corresponding motors can be partially positioned between a phalangeal cavity of a finger phalange and a palm portion of the palm cavity. In yet another example, one or more servo motors that control the abduction-adduction mechanism of the end effector, an abduction-adduction mechanism of a thumb carpometacarpal joint assembly, and/or a flexion-extension mechanism of the thumb carpometacarpal joint assembly can be housed within the palm cavity of the end effector. In a further example, one or more microcontrollers, one or more power supplies, and other components in the electrical system associated with the end effector can be housed within the palm cavity of the end effector.

In some embodiments, the linear actuator assembly for controlling each phalangeal joint assembly in each finger of the end effector can be configured to be self-locking, which can allow each phalange and phalangeal joint assembly in the end effector to maintain its configured position without active motor input, thereby making the end effector beneficial for handling large payloads over extended durations of time. As described hereinbelow, the linear actuator assembly can provide a self-locking feature by configuring a friction angle between a resultant friction force and a normal force between an output shaft of the motor in the linear actuator assembly (e.g., a leadscrew) and a component of the linear actuator assembly that is positioned at an end of the output shaft (e.g., a leadscrew nut) to be greater than a lead angle of the output shaft of the motor in the linear actuator assembly. It should be noted that the self-locking mechanism of the leadscrew assembly can, for example, allow the end effector described herein to support large passive payloads without continuous motor effort, while each finger in the end effector described herein can exert, for example, about 10 Newtons of active force, thereby ensuring a strong and stable grip for effective manipulation. Moreover, the self-locking mechanism of the leadscrew assembly can reduce motor torque demands, thereby making a system that incorporates the end effector described herein to be lighter, more efficient, and cost effective.

In some embodiments, the thumb assembly of the end effector can include three joint assemblies—e.g., an interphalangeal joint assembly that connects a distal phalange of the thumb assembly and a proximal phalange of the thumb assembly, a metacarpophalangeal joint assembly that connects the proximal phalange of the thumb assembly to a metacarpal phalange of the thumb assembly, and a carpometacarpal joint assembly that connects the metacarpal phalange of the thumb assembly to a portion of the palm cavity (e.g., a connector on an exterior wall of the palm cavity that allows the metacarpal phalange of the thumb assembly to be connected). In some embodiments, alternatively to the linear actuator assembly that is used to control the phalangeal joint assemblies in the fingers of the end effector (including the interphalangeal joint assembly and the metacarpophalangeal joint assembly of the thumb assembly), the carpometacarpal joint assembly of the thumb assembly can be actuated or otherwise controlled with a thumb carpometacarpal joint actuation mechanism. It should be noted that the movement of the carpometacarpal joint assembly of the thumb assembly can occur in a different plane than the movement of the phalangeal joint assemblies in the fingers of the end effector.

For example, in some embodiments, the carpometacarpal joint assembly of the thumb assembly can be bi-planar and can provide two degrees of freedom-abduction-adduction and flexion-extension, where thumb abduction-adduction can refer to abduction movements and adduction movements out of the hand plane and where thumb flexion-extension can correspond to flexion movements and extension movements toward or away from the palm. In a more particular example, by using space within the palm cavity, thumb abduction-adduction can be driven by a high-speed servo motor (sometimes referred to herein as a “thumb abduction/adduction motor”) housed within the palm cavity through the active rotation of one or more spur gears. An instruction to the thumb abduction/adduction motor can cause abduction or adduction movements in the carpometacarpal joint assembly of the thumb assembly. In another more particular example, by also using space within the palm cavity, thumb flexion-extension of the carpometacarpal joint assembly can be provided using a servo motor (sometimes referred to herein as a “thumb flexion/extension motor”) that can drive a single-threaded driver worm supported between the motor and the inner palm wall via a ball bearing. An instruction to the thumb flexion/extension motor can cause flexion or extension movements in the carpometacarpal joint assembly of the thumb assembly. In continuing this example, the single-threaded driver worm can mesh or otherwise interact with a worm wheel that has been integrated into the carpometacarpal joint assembly, thereby enabling strong power grasps, finger opposition, and smooth motion.

It should be noted that, in some embodiments, the thumb carpometacarpal joint actuation mechanism in the thumb assembly of the end effector can be configured to be self-locking, which can allow the carpometacarpal joint assembly in the thumb assembly of the end effector to maintain its configured position without active motor input. As described hereinbelow, the thumb carpometacarpal joint actuation mechanism can provide a self-locking feature by configuring the friction angle of the worm gear in the carpometacarpal joint assembly of the thumb assembly to be greater than the lead angle of the single-threaded driver worm in the carpometacarpal joint assembly of the thumb assembly.

In some embodiments, the fingers in the end effector can perform abduction and adduction movements using an abduction-adduction mechanism. For example, in some embodiments, the abduction-adduction mechanism can include a servo motor that is embedded within the palm cavity of the end effector and that is configured to cause a pinion gear to move according to the rotational motion of the servo motor. In continuing this example, the pinion gear can have teeth that mesh with the teeth on a bevel gear portion of a hybrid transmission shaft. The hybrid transmission shaft can, in some embodiments, include worm portions that each interact with a corresponding worm gear located at a finger root or base of one of the finger assemblies of the end effector.

It should be noted that, in some embodiments, the abduction-adduction mechanism can include multiple servo motors that are embedded within the palm cavity of the end effector such that each of the multiple servo motors can be configured to individually perform abduction and/or adduction movements in each finger assembly of the end effector. For example, each of the multiple servo motors can be configured to cause a pinion gear to move according to the rotational motion of the servo motor. In continuing this example, to individually control the abduction and/or adduction movements in each finger assembly, the pinion gear can have teeth that interact with a corresponding worm gear located at a finger root or base of one of the finger assemblies of the end effector. In another example, the pinion gear can have teeth that mesh with the teeth on a bevel gear portion of one of multiple hybrid transmission shafts, where each hybrid transmission shaft can correspond with one finger assembly. The hybrid transmission shaft can, in some embodiments, include a worm portion that interacts with a corresponding worm gear located at a finger root or base of one of the finger assemblies of the end effector.

In some embodiments, the end effector can include a wrist module that supports a palm module that includes the finger assemblies. For example, the wrist module can include multiple linear actuators that each connect an upper wrist platform, which can be configured for mounting the palm module that includes the finger assemblies, with a lower wrist platform, which can be configured for mounting to a robotic system (e.g., a robotic arm or a cobot to lift loads, perform repetitive tasks, and handle larger objects, such as tools, packaging, and automotive parts). It should be noted that the end effector can include a wrist module with two linear actuators across two degrees of freedom—e.g., flexion-extension and radial-ulnar deviation. This can, for example, mimic the motion of a human wrist, thereby enhancing the anthropomorphic qualities of the end effector described herein.

Accordingly, an end effector having multiple fingers can be provided that has, among other things, lightweight construction, high degrees of freedom, high range of motion, anthropomorphism, high payload capacity, large active force, and affordability.

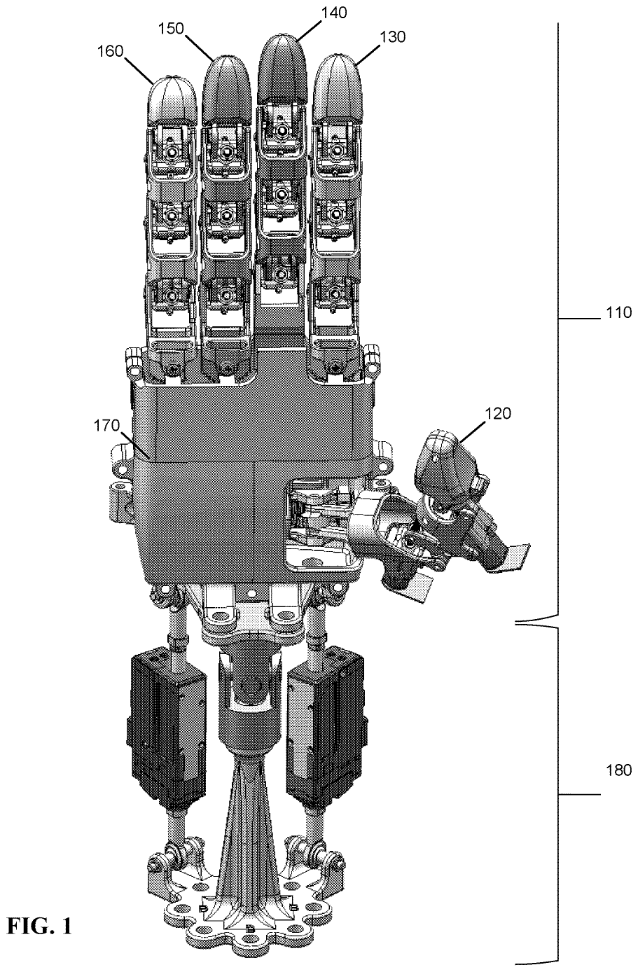

These and other features for providing an end effector having multiple fingers for robotic systems are further described in connection with FIGS. 1-23.

### Leadscrew Finger Actuation Mechanism in the Phalangeal Joints of the Palm Module

In some embodiments, an end effector can include a palm assembly having five fingers, where each finger has multiple phalangeal joint assemblies and where each phalangeal joint assembly in each finger can be independently controlled using a linear actuation assembly that is actuated by a motor. Each finger can have multiple phalangeal cavities in which the linear actuation assembly that independently controls each phalangeal joint assembly can be positioned within one of the phalangeal cavities.

In some embodiments, any suitable linear actuator assembly can be used to control each phalangeal joint assembly. For example, in some embodiments, the linear actuator assembly can include a leadscrew nut that traverses a leadscrew actuated by the motor. In continuing this example, the leadscrew or other suitable output shaft can extend from one end of the motor, where the leadscrew can convert the mechanical energy in the form of rotational motion generated by the motor to drive the leadscrew nut that is connected to an opposing end of the leadscrew.

In some embodiments, the linear actuator assembly used to control each phalangeal joint assembly can be positioned within a phalangeal cavity of a finger phalange. For example, the leadscrew nut can be connected to an upper phalange at a suitable pivot point (e.g., proximal to a base portion of the upper phalange) and the motor or any other suitable motor support structure (e.g., a motor holder or a motor bracket) be connected to a lower phalange or a portion of a palm cavity at a suitable pivot point (e.g., proximal to a base portion of the lower phalange) such that the linear actuator assembly is positioned within a phalangeal cavity of the lower phalange.

It should be noted that, as described herein, the linear actuator assemblies and its corresponding motors for controlling each phalangeal joint assembly can generally be housed within the end effector. For example, the linear actuator assemblies and its corresponding motors can be positioned within a phalangeal cavity of a finger phalange (e.g., along the dorsal side of the finger). In another example, a first portion of the linear actuator assemblies and its corresponding motors can be positioned within a phalangeal cavity of a finger phalange and a second portion of the linear actuator assemblies and its corresponding motors can be positioned within a palm portion of the palm cavity.

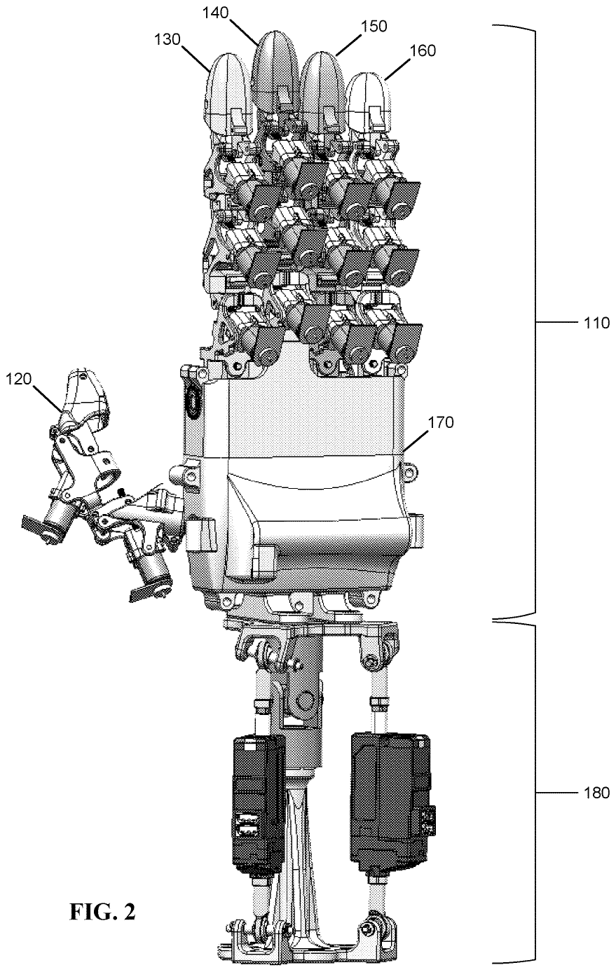

Turning to FIG. 1, an illustrative schematic diagram of an end effector 100 for a robotic system is shown in accordance with some embodiments of the disclosed subject matter. As shown in FIG. 1, end effector 100 can include a palm module 110 having five fingers—e.g., a thumb (D1) 120, a finger (D2) 130, a finger (D3) 140, a finger (D4) 150, and a finger (D5) 160, where the components for controlling each of the joints in the five fingers 120-160 can be contained within phalangeal cavities located along the dorsal side of each finger 120-160 and/or within a palm cavity 170. As also shown in FIG. 1, end effector 100 can include a wrist module 180 that supports palm module 110. FIG. 2 provides an illustrative example of a rear view of end effector 100 in which the back of palm module 100 is shown in accordance with some embodiments of the disclosed subject matter. For example, FIG. 2 shows that motors for actuating leadscrews and other components of the linear actuation mechanism can be positioned within a phalangeal cavity located along the dorsal side of each finger 120-160.

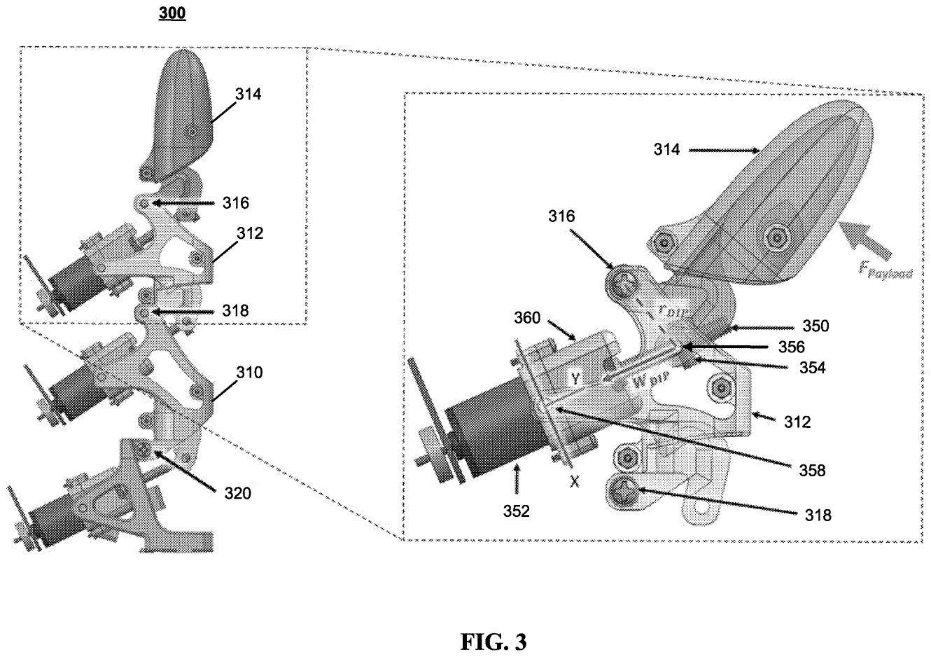

Turning to FIG. 3, an illustrative schematic diagram of a finger assembly 300 corresponding to finger (D2) 130 of FIG. 1 is shown in accordance with some embodiments of the disclosed subject matter. In some embodiments, finger assembly 300 can include three phalanges—e.g., a proximal phalange 310, a medial phalange 312, and a distal phalange 314, where each phalange is connected to at least one other phalange by a phalangeal joint assembly and where each phalange can include a phalange cavity. For example, a distal interphalangeal joint assembly 316 can connect distal phalange 314 and medial phalange 312, a proximal interphalangeal joint assembly 318 can connect medial phalange 312 and proximal phalange 310, and a metacarpophalangeal joint assembly 320 can connect proximal phalange 310 to a portion of palm cavity 170. It should be noted that, although FIG. 3 corresponds to finger (D2) 130 of FIG. 1, the other fingers, such as finger (D3) 140, finger (D4) 150, and finger (D5) 160 can have a similar finger assembly with three phalanges and a phalangeal joint assembly connecting one phalange to another phalange or to a portion of palm cavity 170.

It should be noted that each of these phalangeal joint assemblies can, in some embodiments, flex and extend in the same plane with the linear actuation mechanism described hereinbelow.

It should also be noted that the finger assembly corresponding to thumb (D1) 120 in end effector 100 can also include multiple phalanges and multiple phalangeal joint assemblies, such as an interphalangeal joint assembly that can connect a distal phalange of thumb (D1) 120 and a proximal phalange of thumb (D1) 120 and a metacarpophalangeal joint assembly that can connect a proximal phalange of thumb (D1) 120 to a metacarpal phalange of thumb (D1) 120. In some embodiments, the finger assembly corresponding to thumb (D1) 120 can also include a carpometacarpal joint assembly that can connect the metacarpal phalange of thumb (D1) 120 to a portion of palm cavity 170, where the carpometacarpal joint assembly operates in a different plane from the interphalangeal joint assembly and the metacarpophalangeal joint assembly.

In some embodiments, the movement of each phalangeal joint assembly can be controlled using a linear actuation mechanism. As shown in the exploded view of the linear actuation mechanism in connection with distal interphalangeal joint assembly 316 that connects distal phalange 314 and medial phalange 312, the linear actuation mechanism can include a leadscrew 350 that can be connected to a motor 352, where leadscrew 350 can extend from one end of motor 352. It should be noted that leadscrew 350 is configured to serve as an output shaft of motor 352, where, as the output shaft of motor 352, leadscrew 350 can convert the mechanical energy in the form of rotational motion generated by motor 352 to drive a leadscrew nut 354 that is connected to an opposing end of leadscrew 350 along the longitudinal axis of leadscrew 350. For example, leadscrew nut 354 can be formed from stainless steel with a thread size of about 2.5 millimeters (that is, an M2.5 nut) such that leadscrew nut 354 can be threaded on leadscrew 350.

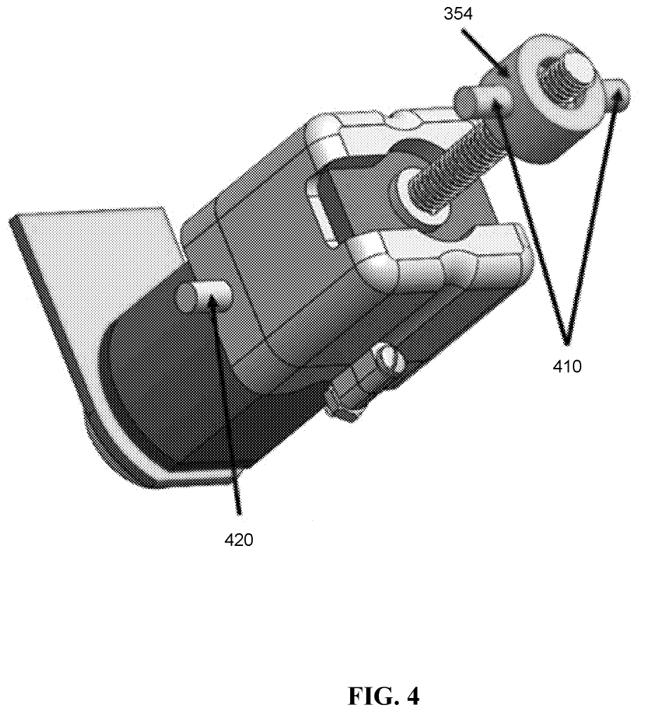

In some embodiments, leadscrew nut 354 can include side protrusions that connect leadscrew nut 354 to an upper phalange at a pivot point 356. For example, as the exploded view of FIG. 3 shows an illustrative example of the linear actuation mechanism corresponding to distal interphalangeal joint assembly 316, leadscrew nut 354 can include two side protrusions that connect leadscrew nut 354 and the linear actuation mechanism to distal phalange 314 at pivot point 356 on distal phalange 314. In a more particular example, as shown in FIG. 4, leadscrew nut 354 can be constructed from stainless steel or any other suitable material to include two cylindrical protrusions 410 (or pins) that are located on opposing ends of leadscrew nut 354 and that fit into corresponding holes on distal phalange 314.

Referring back to FIG. 3, in some embodiments, while the side protrusions can connect leadscrew nut 354 of the linear actuation mechanism to an upper phalange at a pivot point 356, motor 352 can be connected to a lower phalange at a pivot point 358. For example, as shown in FIG. 3, a motor holder 360 or any other suitable mounting bracket can be connected to motor 352, where motor holder 360 can be used to connect motor 352 to a lower phalange at pivot point 358. In a more particular example, as shown in FIG. 4, motor holder 360 can be constructed to include two cylindrical protrusions 420 (or pins) that are located on opposing ends of motor holder 360, where cylindrical protrusions 420 (or pins) can connect motor holder 360 and motor 352 to a lower phalange (e.g., medial phalange 312) at pivot point 358. As such, as shown in FIG. 3, the motor and other components of the linear actuation mechanism can be positioned within a phalangeal cavity of the lower phalange (e.g., medial phalange 312).

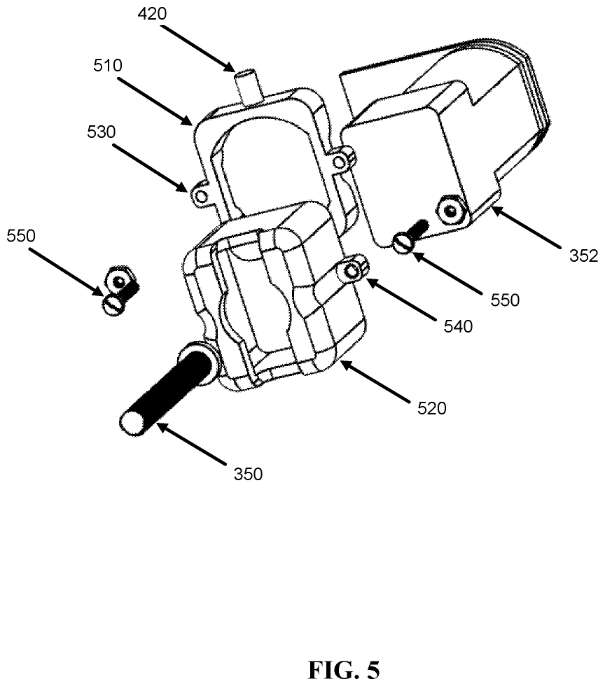

In some embodiments, motor holder 360 (which can be used to secure motor 352 and connect motor 352 to a lower phalange, such as medial phalange 312 in FIG. 3) can be constructed from multiple components. For example, as shown in FIG. 5, motor holder 360 can include a lower mounting bracket 510 that is configured to be positioned around a lower portion of motor 352 and that includes two cylindrical protrusions 420 (or pins) that are located on opposing ends of lower mounting bracket 510, where cylindrical protrusions 420 (or pins) can connect motor holder 360 (which may include lower mounting bracket 510) and motor 352 to a lower phalange, such as medial phalange 312, at pivot point 358. In continuing this example, motor holder 360 can also include an upper mounting bracket 520 that is configured to be positioned around an upper portion of motor 352 (e.g., a gear box casing associated with the motor). In a more particular example, the cross-sectional shape of the lower portion of motor 352 can be different from the cross-sectional shape of the upper portion of motor 352 (e.g., a gear box casing associated with the motor) and, as such, lower mounting bracket 510 can be fabricated to conform to the cross-sectional shape of the lower portion of motor 352 and upper mounting bracket 520 can be fabricated to conform to the cross-sectional shape of the upper portion of motor 352 (e.g., a gear box casing associated with the motor). As also shown in FIG. 5, lower mounting bracket 510 can include two opposing connectors 530 and upper mounting bracket 520 can include two opposing connectors 540 that align with opposing connectors 530 of lower mounting bracket 510 such that screws 550 or any other suitable attachment mechanism can attach lower mounting bracket 510 and upper mounting bracket 520 to form motor holder 360 and to secure motor 352.

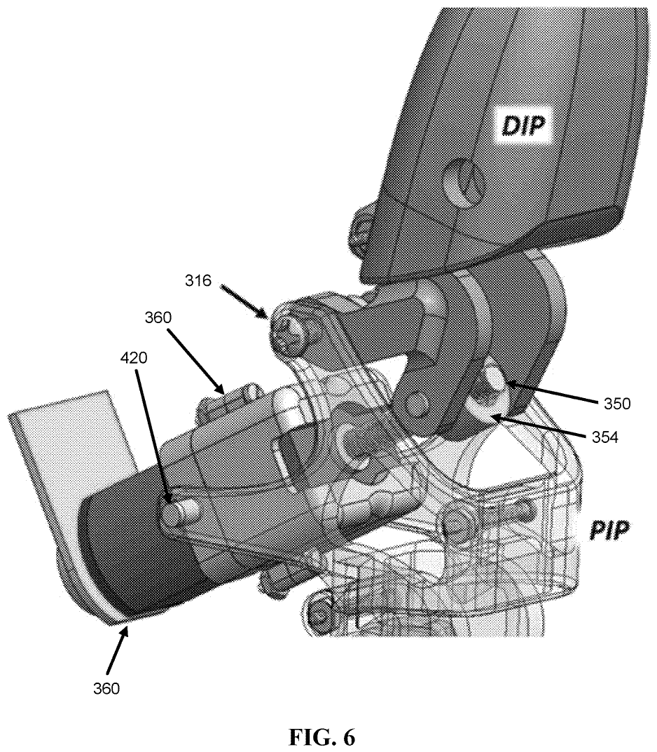

As shown in FIGS. 3 and 6, leadscrew nut 354 having protrusions (such as pins) on opposing ends of leadscrew nut 354 (or any other suitable component positioned on an end of an output shaft, such as leadscrew 350) can fit into pivot point 356 of the phalange above it on the finger—e.g., distal phalange 314. This can allow leadscrew nut 354 to engage the finger (e.g., distal phalange 314) and rotate relative to the finger as part of a two-link rocker mechanism with one variable length link. Referring to FIGS. 3 and 5, rotation of leadscrew 350 can generate an axial force (denoted as WDIP for distal interphalangeal joint assembly 316 in FIG. 3) on leadscrew nut 354, which can subsequently generate a torque around distal interphalangeal joint assembly 316. The torque moment arm is the distance between the phalange joint assembly (e.g., distal interphalangeal joint assembly 316) and the center of leadscrew nut 354, which can be denoted as rDIP in FIG. 3. The generated torque, which can be denoted as FPayload in FIG. 3, can balance any active resistance force at the fingertip.

It should be noted that, although the above-mentioned embodiment generally describes the linear actuation mechanism that drives distal interphalangeal joint assembly 316, this is merely illustrative and each phalangeal joint assembly in end effector 100 can be individually controlled by a corresponding linear actuation mechanism. For example, each phalangeal joint assembly of each finger—e.g., a distal interphalangeal joint assembly that connects a distal phalange and a medial phalange in each of finger (D2) 130, finger (D3) 140, finger (D4) 150, and finger (D5) 160, a proximal interphalangeal joint assembly that connects a medial phalange and a proximal phalange in each of finger (D2) 130, finger (D3) 140, finger (D4) 150, and finger (D5) 160, a metacarpophalangeal joint assembly that connects a proximal phalange to a portion of palm cavity 170—can each be individually controlled by a corresponding linear actuation mechanism as shown in FIGS. 1 and 2. In another example, an interphalangeal joint assembly that connects a distal phalange of thumb (D1) 120 and a proximal phalange of thumb (D1) 120 and a metacarpophalangeal joint assembly that connects a proximal phalange of thumb (D1) 120 to a metacarpal phalange of thumb (D1) 120 can each be individually controlled by a corresponding linear actuation mechanism as shown in FIGS. 1 and 2.

It should also be noted that, while using a motor-driven linear actuation mechanism may increase the number of actuators in end effector 100, end effector 100 can maintain a compact footprint while providing an anthropomorphic palm. It should further be noted that the motor-driven linear actuation mechanism can provide a high gear ratio that can generate significant active forces across a wide range of working conditions, thereby enabling end effector 100 to execute several diverse tasks.

### Self-Locking Mechanism of the Joints in the Palm Module

In some embodiments, as shown in FIGS. 3 and 4, the linear actuation mechanisms can include a self-locking feature of leadscrew 350 (or any other suitable output shaft of motor 352), where a friction angle between a resultant friction force and a normal force between leadscrew 350 and leadscrew nut 354 (or any other suitable linear actuator components that is positioned at an end of the output shaft of motor 354) can be configured such that the friction angle of the phalangeal joint assembly between leadscrew 350 and leadscrew nut 354 is greater than a lead angle of leadscrew 350.

It should be noted that the self-locking feature of the linear actuation mechanism for controlling each phalangeal joint assembly in each finger of the palm assembly can allow each phalange and phalangeal joint assembly in end effector 100 to maintain its configured position without active motor input, thereby making end effector 100 beneficial for handling large payloads over extended durations of time. That is, upon actuating a finger in the palm assembly to the desired kinematics, the finger can maintain its configured position regardless of external forces. This can, for example, simplify control during manipulation and increase payload capacity, which is only limited by the mechanical strength of end effector 100.

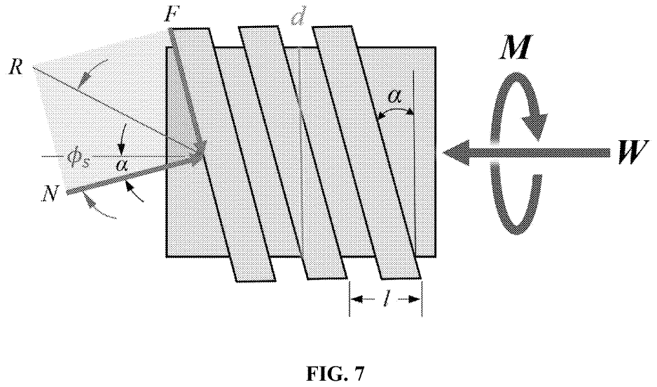

Turning to FIG. 7, FIG. 7 shows an illustrative example of leadscrew 350 (or any other suitable output shaft of motor 352) in a linear actuation mechanism configured to control one of the phalangeal joint assemblies in one of the fingers in the palm assembly in accordance with some embodiments of the disclosed subject matter. In particular, FIG. 7 shows a free body diagram of leadscrew 350 in which rotation of leadscrew 350 can generate an axial force (W) on leadscrew nut 354, which subsequently generates a torque (M). FIG. 7 also depicts the lead angle of leadscrew 350 as a (which can be defined as a measure of steepness of the screw helix of leadscrew 350), the lead of leadscrew 350 as l, the mean diameter of leadscrew 350 as d, and the friction angle of leadscrew 350 as Øs. The friction angle (os) can be defined as the angle between the resultant force R, formed by the normal force, N, and the static friction force, F, for a given coefficient of friction (u) between leadscrew 350 and leadscrew nut 354. The self-locking property of the linear actuation mechanism can be achieved when the selected friction angle (os) of leadscrew 350 is greater than the lead angle of leadscrew 350.

In a more particular example, leadscrew 350 that is incorporated in the motor gearbox of motor 352 can be designed to be a M2.5 screw having a length of about 16 millimeters for the distal interphalangeal joint assembly and the proximal interphalangeal joint assembly in each finger of the palm assembly and having a length of about 20 millimeters for the metacarpophalangeal joint assembly in each finger of the palm assembly. It should be noted that the different lengths of leadscrew 350 can be selected to improve range of motion and, therefore, dexterity of end effector 100. In continuing this example, the lead (l) of leadscrew 350 can be about 0.35 millimeters, the mean diameter (d) of leadscrew 350 can be about 2.50 millimeters, and the coefficient of friction (μ) between leadscrew 350 and leadscrew nut 354 can be about 0.42. The lead angle (α) of leadscrew 350 can be represented by:

$$α = {tan}^{- 1} ( \frac{l}{π d} ) ⟹ α = 2.55 °$$

The friction angle (φₛ) of leadscrew 350 can also be represented by:

$${ϕ}_{s} = {tan}^{- 1} ( \frac{F}{N} ) ⟹ {ϕ}_{s} = {tan}^{- 1} ( μ ) ⟹ {ϕ}_{s} = 21.83 °$$

Accordingly, as the friction angle (φₛ) of leadscrew 350 in the linear actuation mechanism that controls one of the phalangeal joint assemblies in one of the fingers in the palm assembly is greater than the lead angle (α) of leadscrew 350, the linear actuation mechanism includes a leadscrew or other suitable output shaft having a self-locking capability.

### Thumb Carpometacarpal Joint in the Palm Module

Generally speaking, the thumb (D1) 120 in the palm assembly of end effector 100 can be significant in enabling various types of grasps, such as a wide array of gripping and manipulation techniques that are each suited to specific tasks and/or objects. Without the thumb (D1) 120 in the palm assembly of end effector 100, the remaining finger (D2) 130 through finger (D5) 160 may be insufficient for such gripping and manipulation tasks.

In some embodiments, thumb (D1) 120 in the palm assembly of end effector 100 can include at least three joints—an interphalangeal joint assembly that connects a distal phalange of thumb (D1) 120 and a proximal phalange of thumb (D1) 120, a metacarpophalangeal joint assembly that connects the proximal phalange of thumb (D1) 120 to a metacarpal phalange of thumb (D1) 120, and a carpometacarpal joint assembly that connects the metacarpal phalange of thumb (D1) 120 to a portion of palm cavity 170. As mentioned above, it should be noted that, while the phalangeal joint assemblies in finger (D2) 130 through finger (D5) 160 can flex and extend in the same plane using the linear actuation mechanism, the carpometacarpal joint assembly can operate in a different plane from the phalangeal joint assemblies (e.g., the interphalangeal joint assembly and the metacarpophalangeal joint assembly in finger (D2) 130 through finger (D5) 160). This joint movement of the carpometacarpal joint assembly occurring in a different plane can, for example, allow the thumb (D1) 120 to grasp large objects while still allowing the interphalangeal joint assembly to touch the other fingers in the palm assembly of end effector 100.

In some embodiments, alternatively to the linear actuation mechanism described above that is used to control the phalangeal joint assemblies in finger (D2) 130 through finger (D5) 160 and the interphalangeal joint assembly and the metacarpophalangeal joint assembly of thumb (D1) 120, the carpometacarpal joint of thumb (D1) 120 can be actuated or otherwise controlled with a thumb carpometacarpal joint actuation mechanism. Such a thumb carpometacarpal joint actuation mechanism can, for example, allow the thumb of end effector 100 to achieve powerful grasps with high speeds.

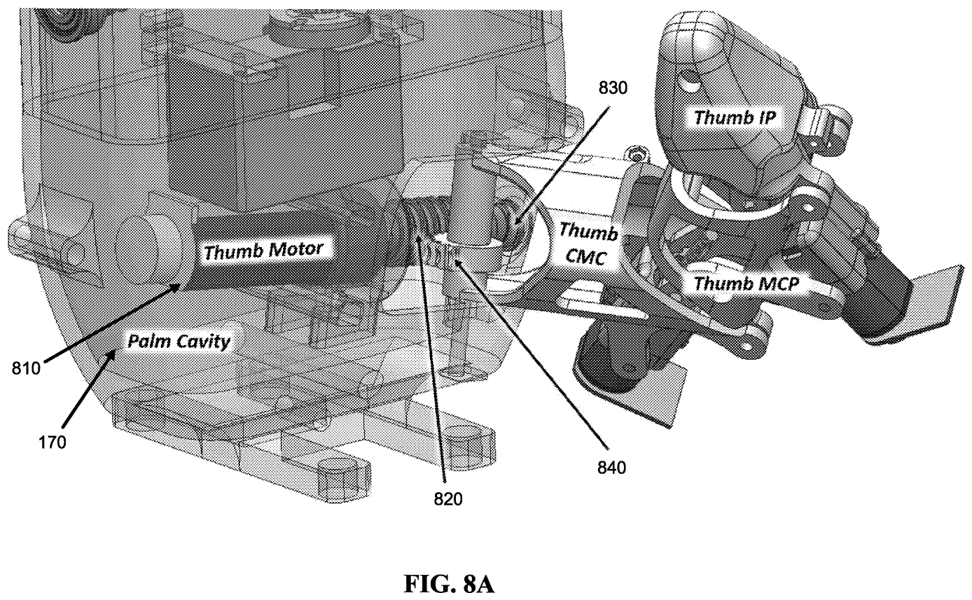

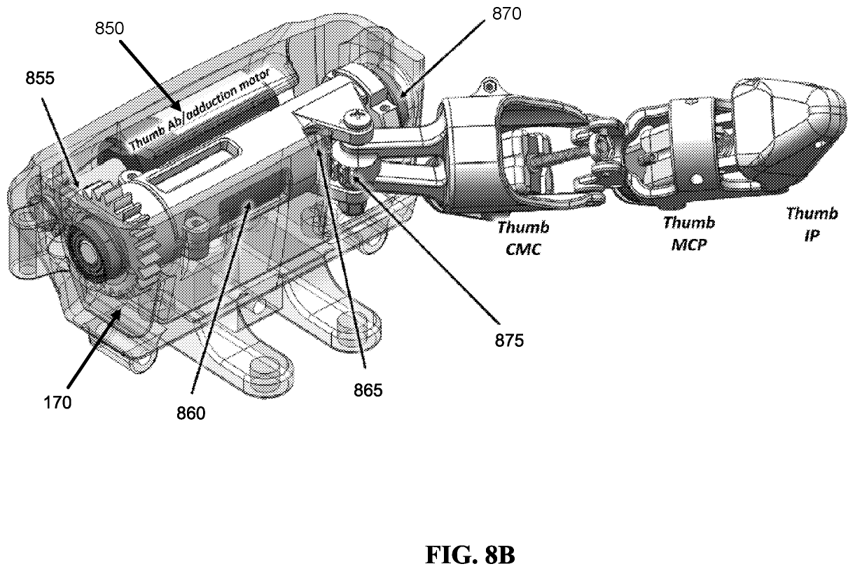

In some embodiments, as shown in FIG. 8A, the thumb carpometacarpal joint actuation mechanism can include a thumb motor 810 that is connected to a worm gear 820, where worm gear can rotate a worm wheel 840 that is connected to the carpometacarpal joint assembly of thumb (D1) 120. For example, as shown in FIG. 8A, thumb motor 810 can be a high speed direct current (DC) motor that, when providing a rotational motion, drives a single-threaded driver worm 820 that is connected to thumb motor 810. In continuing this example, single-threaded driver worm 820 can be pinned to an inner wall of palm cavity 170 using a ball bearing 830. As single-threaded driver worm 820 is actuated by thumb motor 810, single-threaded driver worm 820 can rotate worm wheel 840 that meshes with single-threaded driver worm 820 at about ninety degrees. For example, as shown in FIG. 8A, the teeth on worm wheel 840 can be formed to interact with the helical tooth of single-threaded driver worm 820.

It should be noted that, in some embodiments, worm wheel 840 can be formed to be a part of the link to the carpometacarpal joint assembly of thumb (D1) 120. For example, as shown in FIG. 8A, worm wheel 840 can be formed around a cylindrical post of the carpometacarpal joint assembly of thumb (D1) 120.

In some embodiments, FIGS. 8B and 8C show an alternative thumb carpometacarpal joint actuation mechanism in which the movement of the thumb carpometacarpal joint actuation mechanism can occur in a different plane than the movement of the phalangeal joint assemblies in the fingers of the end effector. For example, the carpometacarpal joint actuation mechanism of thumb (D1) 120 can be bi-planar and can provide two degrees of freedom—(1) abduction-adduction and (2) flexion-extension. It should be noted that thumb abduction-adduction can refer to abduction movements and adduction movements out of the hand plane and thumb flexion-extension can correspond to flexion movements and extension movements toward or away from the palm. By providing thumb abduction-adduction and thumb flexion-extension, the end effector can have a stable grasp of large objects while preserving thumb opposition, allowing thumb (D1) 120 to reach the fingertips of finger (D2) 130 through finger (D5) 160.

As shown in FIGS. 8B and 8C, by using space within palm cavity 170, thumb abduction-adduction can be driven by a servo motor 850 (e.g., a high-speed servo motor or any other suitable motor) housed within palm cavity 170, where servo motor 850 can be configured to control the active rotation of one or more spur gears 855. An instruction to servo motor 850 can cause abduction or adduction movements in the carpometacarpal joint assembly of the thumb assembly. It should be noted that, in some embodiments, one or more spur gears 855 can be formed or otherwise integrated at an end of a drive shaft connected to servo motor 850.

In continuing this example, by also using space within palm cavity 170, thumb flexion-extension of the carpometacarpal joint assembly can be provided using a servo motor 860 that can drive a single-threaded driver worm 865 supported between motor 860 and the inner palm wall via a ball bearing 870. An instruction to servo motor 860 can cause flexion or extension movements in the carpometacarpal joint assembly of the thumb assembly. As single-threaded driver worm 865 is actuated by motor 860, single-threaded driver worm 865 can rotate worm wheel 875 that meshes with single-threaded driver worm 865. Worm 865 driven by motor 860 can mesh with a worm wheel 875 that has been integrated into the carpometacarpal joint assembly, thereby enabling strong power grasps, finger opposition, and smooth motion.

It should also be noted that, while the motors and other components of the linear actuation mechanism described above that are used to control the phalangeal joint assemblies in finger (D2) 130 through finger (D5) 160 and the interphalangeal joint assembly and the metacarpophalangeal joint assembly of thumb (D1) 120 are generally described as being positioned within one of multiple phalangeal cavities, the motor, the worm, the worm wheel, and the other components of carpometacarpal joint of thumb (D1) 120 can generally be positioned within the palm cavity 170 of end effector 100.

As described above in connection with the phalangeal joint assemblies in which the linear actuation mechanism that controls each of the phalangeal joint assemblies can include a leadscrew that is self-locking (e.g., by configuring the friction angle (Øs) of leadscrew 350 in the linear actuation mechanism that controls one of the phalangeal joint assemblies in one of the fingers in the palm assembly to be greater than the lead angle (α) of leadscrew 350), single-threaded driver worm 820 in FIG. 8A and/or single-threaded driver worm 865 in FIGS. 8B and 8C can also be configured such that the carpometacarpal joint assembly of thumb (D1) 120 can be self-locking. As such, the thumb (D1) 120 of palm assembly along with the other fingers of palm assembly, where each phalangeal joint assembly can be configured to be self-locking, can hold a payload in position without the motors continuously running during the payload grasp and cannot be back-driven by the payload, thereby conserving energy and reducing wear and tear.

In a more particular example, the lead angle of single-threaded driver worm 820 in FIG. 8A and/or single-threaded driver worm 865 in FIGS. 8B and 8C can be defined as a (which can be defined as a measure of steepness of the screw helix of single-threaded driver worm 820 in FIG. 8A and/or single-threaded driver worm 865 in FIGS. 8B and 8C), the lead of single-threaded driver worm 820 in FIG. 8A and/or single-threaded driver worm 865 in FIGS. 8B and 8C can be defined as L (which can be about 2.5 millimeters for single-threaded driver worm 820 in FIG. 8A and/or single-threaded driver worm 865 in FIGS. 8B and 8C), and the pitch diameter of single-threaded driver worm 820 in FIG. 8A and/or single-threaded driver worm 865 in FIGS. 8B and 8C can be defined as d (which can be 9.49 millimeters for single-threaded driver worm 820 in FIG. 8A and/or single-threaded driver worm 865 in FIGS. 8B and 8C). Similar to the equation shown above in calculating the lead angle of leadscrew 350, the lead angle of single-threaded driver worm 820 in FIG. 8A and/or single-threaded driver worm 865 in FIGS. 8B and 8C can be represented by:

$$α = {tan}^{- 1} ( \frac{L}{π d} ) = ⇒ σ = 4.8 °$$

The friction angle (φₛ) of the carpometacarpal joint assembly of thumb (D1) 120 can be defined as the angle between the resultant force R, formed by the normal force, N, and the static friction force, F, for a given coefficient of friction (μ) between the single-threaded driver worm (e.g., single-threaded driver worm 820 in FIG. 8A and/or single-threaded driver worm 865 in FIGS. 8B and 8C) and the worm wheel (e.g., worm wheel 840 in FIG. 8A, worm wheel 875 in FIGS. 8B and 8C, or any other suitable worm gear at the carpometacarpal joint). The self-locking property of the carpometacarpal joint assembly of thumb (D1) 120 can be configured when the selected friction angle (φₛ) is greater than the lead angle of single-threaded driver worm 820 in FIG. 8A and/or single-threaded driver worm 865 in FIGS. 8B and 8C.

Similar to the equation shown above in calculating the friction angle between leadscrew 350 and leadscrew nut 354, the friction angle (Øs) of the worm gear at the carpometacarpal joint assembly of thumb (D1) 120 can be represented as:

$${ϕ}_{s} = {tan}^{- 1} ( \frac{F}{N} ) = {ϕ}_{s} = {tan}^{- 1} ( μ ) = {ϕ}_{s} = 24.7 °$$

Accordingly, as the friction angle (φₛ) of the worm gear in the thumb carpometacarpal joint actuation mechanism that controls the carpometacarpal joint assembly in the thumb (D1) 120 of the palm assembly is greater than the lead angle (α) of the single-threaded driver worm (e.g., single-threaded driver worm 820 in FIG. 8A and/or single-threaded driver worm 865 in FIGS. 8B and 8C), the thumb carpometacarpal joint actuation mechanism having a worm gear that includes a single-threaded driver worm (e.g., single-threaded driver worm 820 in FIG. 8A and/or single-threaded driver worm 865 in FIGS. 8B and 8C) and a worm wheel (e.g., worm wheel 840 in FIG. 8A and/or worm wheel 975 in FIGS. 8B and 8C) can be configured to have a self-locking capability.

### Abduction-Adduction Mechanism of the Fingers in the Palm Module

In some embodiments, the fingers in the palm module can perform abduction and adduction movements using an abduction-adduction mechanism. This degree of freedom can, for example, line in a plane orthogonal to the flexion-extension of the fingers of end effector 100.

Generally speaking, the abduction movements in which the fingers in the palm module can spread apart can allow end effector 100 to adapt to the shape and/or size of objects, improve surface content, and/or ensure a secure grip. Such abduction movements can be essential for manipulating larger objects and distributing force more evenly across a payload, thereby preventing slippage. On the other hand, adduction movements in which the fingers in the palm module can be brought together can allow end effector 100 to create a firm and stable grip, particularly for small and/or delicate objects. These abduction movements and adduction movements can create end effector 100 having a balance of precision and strength, thereby supporting a wide range of manipulation tasks (e.g., from handling fragile objects to power gripping in labor-intensive activities).

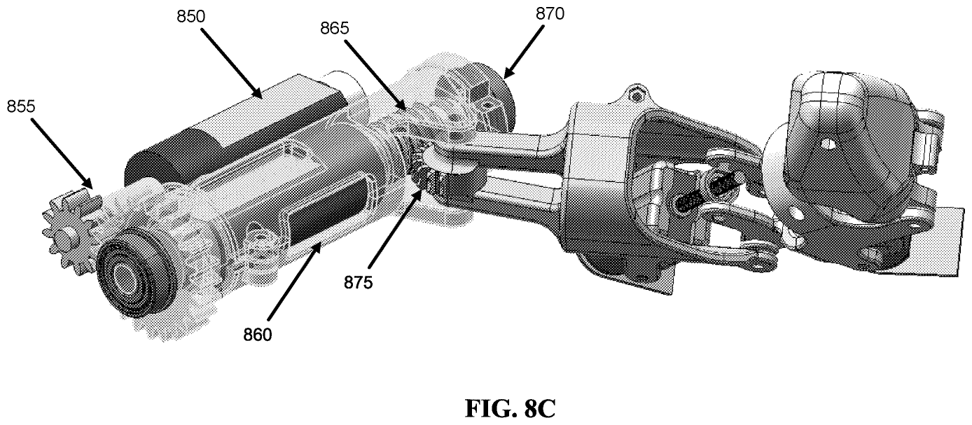

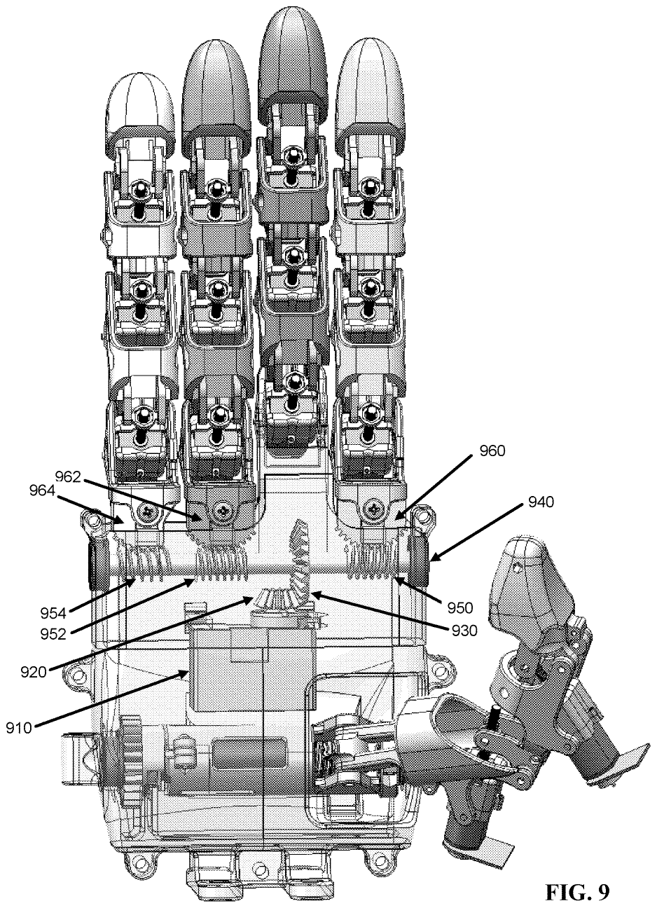

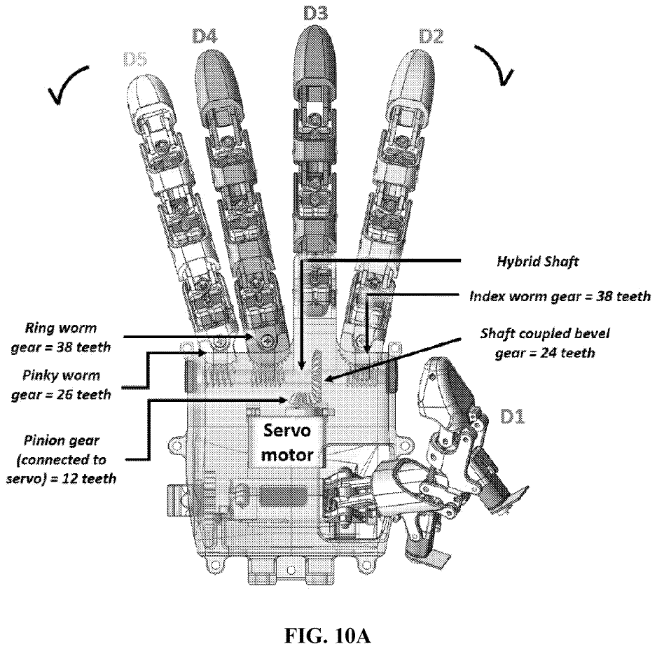

Turning to FIGS. 9, 10A, and 10B, an illustrative end effector in which an abduction-adduction mechanism is configured within a palm cavity of the end effector is shown in accordance with some embodiments of the disclosed subject matter.

As shown in FIG. 9, in some embodiments, the abduction-adduction mechanism can include a servo motor 910 that is configured to cause a pinion gear 920 or any other suitable gear structure to move according to the rotational motion of servo motor 910. For example, servo motor 910 can be configured to be embedded within palm cavity 170 of end effector 100, where servo motor 910 can be connected to pinion gear 920 having a particular number of teeth (e.g., twelve teeth) that mesh with a bevel gear portion 930 of a hybrid transmission shaft 940 (e.g., having twenty-four teeth). Accordingly, as pinion gear 920 is configured to move based on the motion generated from servo motor 910, pinion gear 920 can be configured to cause bevel gear portion 930 and hybrid transmission shaft 940 to move as the teeth of pinion gear 920 mesh with the teeth of bevel gear portion 930.

In addition to bevel gear portion 930 being formed on hybrid transmission shaft 940, hybrid transmission shaft 940 can also include multiple worm portions 950, 952, and 954 that each correspond to one of the finger assemblies of the palm module. As shown in FIG. 9, worm portion 950 on hybrid transmission shaft 940 can be connected to a worm gear 960 (e.g., an index worm gear) located at the base of finger (D2) 130, worm portion 952 on hybrid transmission shaft 940 can be connected to a worm gear 962 (e.g., a ring worm gear) located at the base of finger (D4) 150, and worm portion 952 on hybrid transmission shaft 940 can be connected to a worm gear 964 (e.g., a pinky worm gear) located at the base of finger (D5) 160. As bevel gear portion 930 and hybrid transmission shaft 940 are actuated by the movement of pinion gear 920, each worm portion 950, 952, and 954 can be simultaneously driven, where each worm portion 950, 952, and 954 can be connected to mesh with a corresponding worm gear 960, 962, and 964 associated with a finger on the palm module.

It should be noted that, although the embodiment described in FIG. 9 shows that worm portion 950 on hybrid transmission shaft 940 is connected to worm gear 960 located at the base of finger (D2) 130, that worm portion 952 on hybrid transmission shaft 940 is connected to worm gear 962 located at the base of finger (D4) 150, and that worm portion 952 on hybrid transmission shaft 940 is connected to worm gear 964 located at the base of finger (D5) 160, this is merely illustrative and a worm gear can be used to connect to a corresponding worm portion on hybrid transmission shaft 940 for any suitable combination of fingers of the palm module. For example, the abduction-adduction mechanism can include multiple worm gears that are each located at the base of each finger—e.g., finger (D2) 130, finger (D3) 140, finger (D4) 150, and finger (D5) 160, where each worm gear can interact with a corresponding worm portion on hybrid transmission shaft 940. In another example, the abduction-adduction mechanism can include multiple worm gears that are each located at the base of a different set of fingers, such as finger (D2) 130, finger (D3) 140, and finger (D5) 160, where each worm gear can interact with a corresponding worm portion on hybrid transmission shaft 940. In yet another example, one finger, such as finger (D3) 140, can be excluded from being controlled by the abduction-adduction mechanism to provide a symmetric power grasp configuration of end effector 100.

It should also be noted that each of the gears in the abduction-adduction mechanism can have any suitable number of teeth. For example, in some embodiments, pinion gear 920 that is connected to servo motor 910 can have twelve teeth that mesh with the twenty-four teeth on bevel gear portion 930 on hybrid transmission shaft 940. In another example, worm gear 960 that interacts with worm portion 950 of hybrid transmission shaft 940 and worm gear 962 that interacts with worm portion 952 of hybrid transmission shaft 940 can each have thirty-eight teeth, while worm gear 964 that interacts with worm portion 954 of hybrid transmission shaft 940 can have twenty-six teeth.

It should further be noted that the worm portions of hybrid transmission shaft 940 can have any suitable orientation. For example, as shown in FIG. 9 in which each worm portion on hybrid transmission shaft 940 can engage with a worm gear or a worm wheel located at a corresponding finger root, worm portion 950 can be left-handed oriented, while worm portion 952 and worm portion 954 can be right-handed oriented. This can, for example, allow finger (D4) 150 and finger (D5) 160 that correspond with worm portion 952 and worm portion 954 to move in the same direction, while finger (D2) 130 that corresponds with worm portion 950 can move in the opposite direction. For example, FIG. 10A shows that actuating worm portion 952 to move worm gear 962 and actuating worm portion 954 to move worm gear 964 can cause finger (D4) 150 and finger (D5) 160 to abduct or spread out in the same direction, while actuating worm portion 950 to move worm gear 960 can cause finger (D2) 130 to abduct or spread out in an opposing direction.

Additionally, in some embodiments, the worm portions of hybrid transmission shaft 940 can have any suitable pitch. For example, the worm pitch for worm portion 950 that corresponds with worm gear 960 located at the finger root of finger (D2) 130 and the worm pitch for worm portion 952 that corresponds with worm gear 962 located at the finger root of finger (D4) 150 can be about 2 millimeters, while the worm pitch for worm portion 954 that corresponds with worm gear 964 located at the finger root of finger (D5) 140 can be about 2.63 millimeters. This greater worm pitch for worm portion 954 can, for example, allow finger (D5) 140 to move faster than finger (D2) 130 and finger (D4) 150, thereby achieving a larger span in the same amount of time.

Similar to the self-locking capability described above in connection with leadscrew 350 that drives a phalangeal joint assembly and driver worm 820 that drives a carpometacarpal joint assembly, the worm gears located at each base or finger root in the abduction-adduction mechanism can also be configured to be self-locking, thereby making this degree of freedom non-backdrivable as well.

It should be noted, although the embodiment described in FIG. 9 shows that a single servo motor 910 is connected to pinion gear 920, where pinion gear 920 is configured to interact with bevel gear portion 930 on hybrid transmission shaft 940 and where the movement of hybrid transmission shaft 940 causes each worm gear (e.g., worm gear 950, 952, or 954) formed on hybrid transmission shaft 940 to interact with a corresponding worm gear (e.g., worm gear 960, 962, or 964), this is merely illustrative and end effector 100 can include any suitable number of servo motors within palm cavity 170. For example, as shown in FIG. 10B, the abduction-adduction mechanism can independently control the abduction and/or adduction movements of each finger assembly in end effector 100 by implementing multiple servo motors 1010, 1020, 1030, and 1040 that are housed within palm cavity 170. In a more particular example, four servo motors can be positioned within palm cavity 170, where each servo motor 1010, 1020, 1030, and 1040 can individually control an abduction-adduction mechanism associated with one finger. In continuing this example, each servo motor 1010, 1020, 1030, and 1040 can be configured to cause a worm gear located at a finger root or base of one of the finger assemblies of the end effector to move according to the rotational motion of the servo motor. Alternatively, in another example, each servo motor 1010, 1020, 1030, and 1040 can cause the movement of a corresponding worm gear located at the finger root of one of finger (D2) 130, finger (D3) 140, finger (D4) 150, and finger (D5) 160 via a pinion gear, a bevel gear, a worm located on a hybrid shaft, etc.). That is, in this example, each of the multiple servo motors 1010, 1020, 1030, and 1040 can be configured to cause a pinion gear to move according to the rotational motion of the servo motor. In continuing this example, to individually control the abduction and/or adduction movements in each finger assembly, the pinion gear can have teeth that mesh with the teeth on a bevel gear portion of one of multiple hybrid transmission shafts, where each hybrid transmission shaft can correspond with one finger assembly. The hybrid transmission shaft can, in some embodiments, include a worm portion that interacts with a corresponding worm gear located at a finger root or base of one of the finger assemblies of the end effector.

By placing four servo motors within palm cavity 170 for independent abduction-adduction of finger (D2) 130, finger (D3) 140, finger (D4) 150, and finger (D5) 160 can, for example, extend the number of degrees of freedom from nineteen degrees of freedom in the above-mentioned embodiments to twenty-two degrees of freedom.

### The Wrist Module of the End Effector

In some embodiments, the end effector can include a wrist module that enhances versatility, strength, and precision for hand manipulation. For example, referring back to FIGS. 1 and 2, end effector 100 can include wrist module 180 that supports palm module 110 having five fingers—e.g., thumb (D1) 120, finger (D2) 130, finger (D3) 140, finger (D4) 150, and finger (D5) 160—and having palm cavity 170.

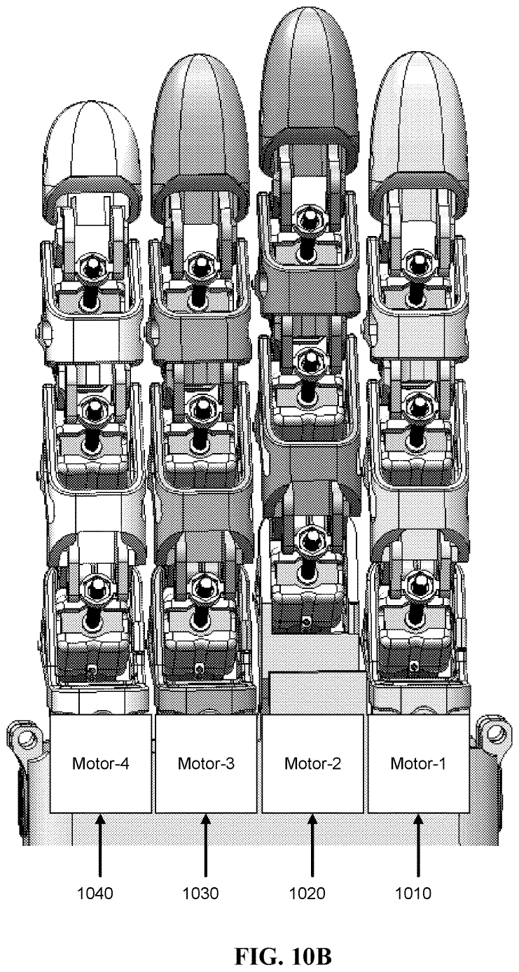

FIG. 11 shows an illustrative example of a wrist module in which an upper portion of the wrist module can be connected to a palm module of an end effector and a lower portion of the wrist module can be connected to a robotic system (such as an industrial or collaborative robotic arm system) in accordance with some embodiments of the disclosed subject matter. Turning to FIG. 11, wrist module 180 can be a two degree of freedom motion platform for supporting palm module 110 of end effector 100.

In some embodiments, wrist module 180 can include multiple linear actuators 1110 (e.g., two linear actuators) that each connect an upper wrist platform 1120, which can be configured for mounting palm module 110, with a lower wrist platform 1130, which can be configured for mounting to a robotic system (e.g., a robotic arm or a cobot to lift loads, perform repetitive tasks, and handle larger objects, such as tools, packaging, and automotive parts). For example, each linear actuator 1110 can have a stroke length of about 26.92 millimeters for extending or displacing a rod 1140 or any other suitable moving structure and a dynamic force of about 100 Newtons. In another example, linear actuators 1110 together can provide a combined force of about 200 Newtons.

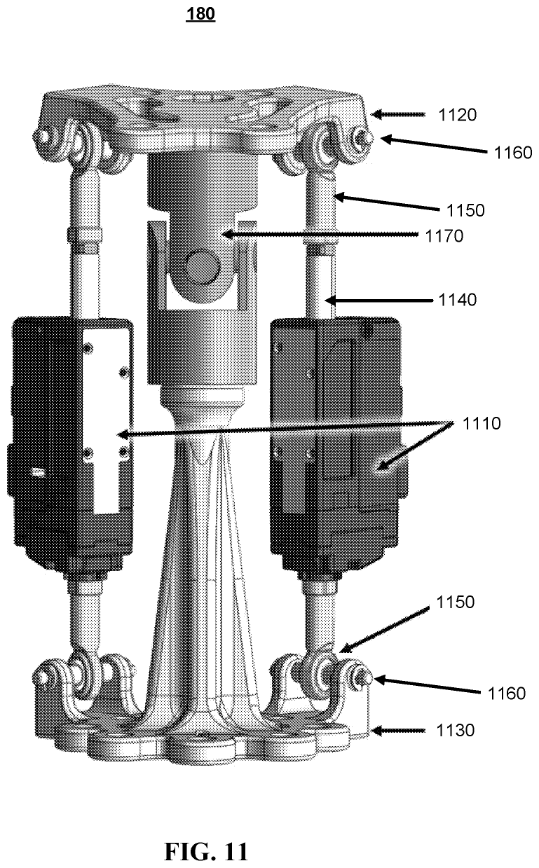

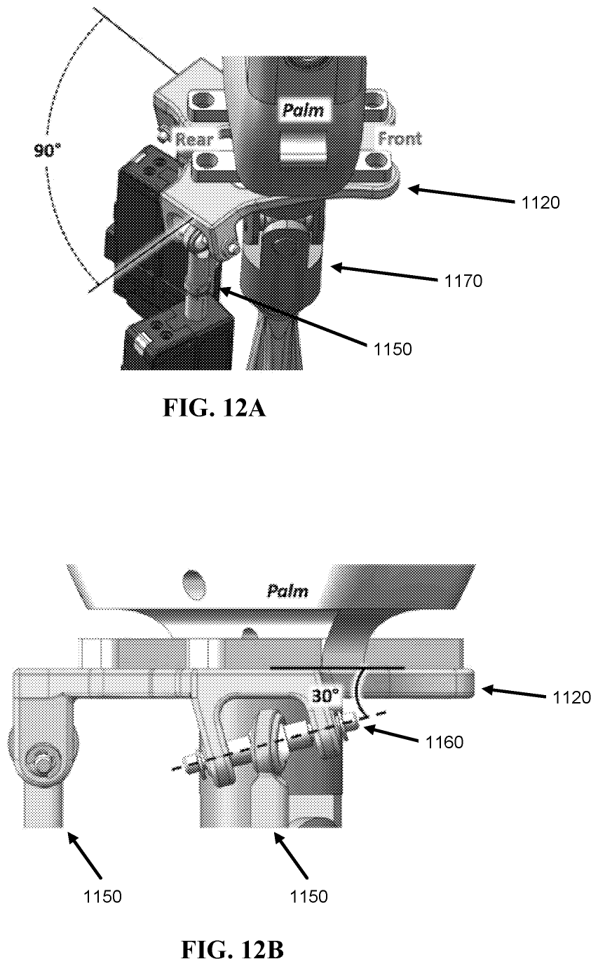

It should be noted that linear actuators 1110 can be connected to upper wrist platform 1120 and lower wrist platform 1130 in any suitable manner. For example, opposing ends of linear actuator can each have a spherical joint 1150 or a fisheye joint, such as spherical joint 1150 connected to an end of rod 1140 and spherical joint 1150 connected to an opposing end of linear actuator 1110. In a more particular example, spherical joints 1150 associated with linear actuators 1110 can be configured to be positioned about ninety degrees apart from each other on the rear side of end effector 100. This is shown, for example, in FIG. 12A.

In continuing this example, each spherical joint 1150 can be connected to a connection point on upper wrist platform 1120 or a connection point on lower wrist platform 1130 using a clevis pin 1160 or any other suitable attachment mechanism. In a more particular example, the spherical joints 1150 connected to linear actuator 1110 can be attached at particular portions of upper wrist platform 1120 and lower wrist platform 1140, where such portions of upper wrist platform 1120 and lower wrist platform 1140 can have two corresponding holes on each end of the wrist platform for receiving a clevis having an opening at a distal end that receives a clevis pin. In some embodiments, alternatively to a clevis pin that is received at a distal end of a clevis, portions of upper wrist platform 1120 and lower wrist platform 1140 can have two corresponding holes on each end of the wrist platform for receiving a clevis having a suitable groove at a distal end that receives a circular clip, a ring, or any other suitable fastener.

In some embodiments, as shown in FIG. 11, wrist module 180 can include a wrist joint assembly 1170. For example, as shown in FIG. 11, wrist joint 1170 can link upper wrist platform 1120 and lower wrist platform 1130, where wrist joint assembly 1170 can be a ninety degree universal joint that is configured to perform both flexion-extension and radial-ulnar deviation at a single joint. It should be noted that, as shown in FIG. 12B, upper wrist platform 1120 can be configured to have a bank angle of about thirty degrees between the horizon and the axis of spherical joint 1150. This can, for example, allow each spherical joint 1150 that is connected to upper wrist platform 1120 to sweep a larger angle before contacting the casing of spherical joint 1150, thereby increasing the range of motion for flexion-extension and/or radial-ulnar deviation.

It should be noted that, in using the above-mentioned configuration for wrist module 180 (e.g., a ninety degree universal joint for wrist joint assembly 1170 and configuring upper wrist platform 1120 to have a bank angle of about thirty degrees between the horizon and the axis of spherical joint 1150), wrist module 180 can be capable of achieving a forward flexion of about fifty-two degrees, a backward extension of about eighteen degrees, and a radial-ulnar deviation of about eighteen degrees.

### The Electrical System of the End Effector

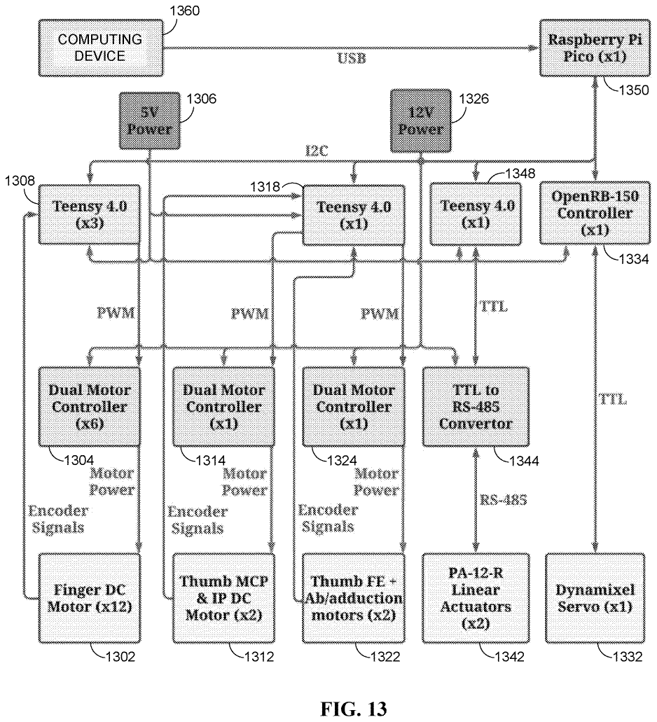

FIG. 13 shows an illustrative block diagram of an electrical system 1300 for controlling the actuation mechanisms in end effector 100 in accordance with some embodiments of the disclosed subject matter.

In some embodiments, the movement of each phalangeal joint assembly in the fingers D2 through D5 of end effector 100 and the movement of the phalangeal joint assemblies in the thumb D1 of end effector (e.g., excluding thumb flexion-extension movements and thumb abduction-adduction movements) can be independently controlled with the linear actuation mechanism described above, where the linear actuation mechanism can include a direct current motor with an encoder (such as a micro direct current motor with an embedded encoder). For example, as shown in FIG. 13, there are twelve phalangeal joint assemblies in the fingers D2 through D5 of end effector 100 and two phalangeal joint assemblies in the thumb D1 of end effector 100. In continuing this example, each of the phalangeal joint assemblies in the fingers D2 through D5 of end effector 100 can be actuated using a motor with an encoder 1302 (shown as finger DC motor in FIG. 13) and each of the phalangeal joint assemblies in the thumb D1 of end effector 100 can be actuated using a motor with an encoder 1312 (shown as thumb MCP and IP DC motor in FIG. 13). Together, the fourteen direct current motors 1302 and 1312 can provide fourteen degrees of freedom for end effector 100.

In some embodiments, electrical system 1300 can include multiple motor controllers 1304 for independently controlling and receiving feedback from motors 1302 associated with the fingers D2 through D5 of end effector 100 (shown as dual motor controllers in FIG. 13) and motor controller 1314 for independently controlling and receiving feedback from motors 1312 associated with the thumb D1 of end effector 100 (shown as a dual motor controller in FIG. 13). For example, as shown in FIG. 13, each motor controller 1304 can be a two-channel motor controller that independently controls and receives encoder signals and other feedback from two motors (e.g., a set of two from the multiple motors 1302 associated with the fingers D2 through D5 of end effector 100 and motors 1312 associated with the thumb D1 of end effector 100). As also shown in FIG. 13, the fourteen direct current motors 1302 and 1312 (e.g., operating at a maximum voltage of 12 volts) can be managed by seven dual/single direct current motor drivers that can each be independently controlling and receiving feedback from two motors. In continuing this example, each motor control 1304 and 1314 can be connected to a single power supply 1306, where motor controllers 1304 can be arranged in parallel, thereby ensuring uniform voltage. In a more particular example, each motor controller 1304 and 1314 can receive power that is supplied through a single power source (e.g., operating at a maximum voltage of 12 volts).

In some embodiments, each motor controller 1304 and 1314 can be connected to one of multiple microcontrollers 1308 and 1318. In a more particular example, each motor controller 1304 and 1314 can receive power that is supplied through a single power source (e.g., operating at a maximum voltage of 12 volts) and can communicate through microcontrollers 1308 and 1318, thereby allowing for independent motor control. As shown in FIG. 13, six motor controllers 1304 associated with twelve motors 1302 in the finger phalangeal joint assemblies and each of twelve motors 1302 in the finger phalangeal joint assemblies can communicate with one of three microcontrollers 1308, where encoder signals can be transmitted from each of twelve motors 1302 in the finger phalangeal joint assemblies to one of three microcontrollers 1308 and power signals (e.g., pulse width modulation signals) can be transmitted from one of three microcontrollers 1308 to one of six motor controllers 1304 (which, in turn, can transmit motor power signals to one of twelve motors 1302 in a finger phalangeal joint assembly). As also shown in FIG. 13, motor controller 1314 associated with the thumb metacarpophalangeal joint assembly and the thumb interphalangeal join assembly can communicate with microcontroller 1318, where encoder signals can be transmitted from each of two motors 1312 in the thumb metacarpophalangeal joint assembly and the thumb interphalangeal join assembly to microcontroller 1318 and power signals (e.g., pulse width modulation signals) can be transmitted from microcontroller 1318 to motor controller 1314 (which, in turn, can transmit motor power signals to one of motors 1312). As further shown in FIG. 13, motor controller 1324 associated with the thumb flexion-extension and thumb abduction-adduction portions of the carpometacarpal joint assembly of the thumb can communicate with microcontroller 1318, where encoder signals can be transmitted from each of two motors 1322 in the carpometacarpal joint assembly of the thumb to microcontroller 1318 and power signals (e.g., pulse width modulation signals) can be transmitted from microcontroller 1318 to motor controller 1324 (which, in turn, can transmit motor power signals to one of motors 1322).

It should be noted that the encoders in each direct current motors 1302, 1312, and 1322 can provide encoder signals that allow a microcontroller (e.g., one of microcontrollers 1308 and 1318) to interpret the finger position in real time, thereby forming a closed-loop control.

It should also be noted that, in some embodiments, the movement of the carpometacarpal joint assembly in the thumb D1 of end effector 100 can also be independently controlled with the thumb carpometacarpal joint actuation mechanism described above, where the thumb carpometacarpal joint actuation mechanism can include multiple direct current motors with an encoder 1322—e.g., one direct current motor for thumb flexion-extension movements and another direct current motor for thumb abduction-adduction movements. For example, as shown in FIG. 13, the carpometacarpal joint assembly in the thumb D1 can be actuated using multiple motors each having an encoder 1322, thereby providing two additional degrees of freedom. It should be noted that motors 1322 can be different from motors 1302 and 1312 to provide the power and torque that may be needed at the carpometacarpal joint assembly in the thumb D1 of end effector 100. For example, as the thumb carpometacarpal joint actuation mechanism may sometimes bear the full payload weight of end effector 100, direct current motors 1322 can be stronger motors than motors 1302 and 1312. Motor 1322 can be positioned in the palm cavity of end effector 100. In some embodiments, motor 1322 can operate on a separate power supply (e.g., a separate 12 volt power supply).

In some embodiments, electrical system 1300 can include a motor controller 1324 for independently controlling and receiving feedback from motor 1322. For example, as shown in FIG. 13, motor controller 1324 can be a two-channel motor controller that independently controls and receives encoder signals and other feedback from motor 1322. In continuing this example, as mentioned above, motor controller 1324 can be connected to a single power supply 1326 that is separate from power supply 1306.

In some embodiments, microcontroller 1318 can be connected to motor controllers 1314 for independently controlling and receiving feedback from motors 1312 in the phalangeal joint assemblies of thumb D1 of end effector 100 and can also be connected to motor controller 1324 for independently controlling and receiving feedback from motors 1322 in the carpometacarpal joint assembly of thumb D1 of end effector 100.

In some embodiments, the abduction-adduction finger actuation mechanism by the fingers in end effector 100 can be controlled by a servo motor 1332. Servo motor 1332 can be housed within the palm cavity of the palm module and can communicate with a controller 1334 in electrical system 1300 via a suitable communication protocol (e.g., transistor-transistor logic or TTL). As servo motor 1332 controls the abduction and adduction of the fingers in end effector 100, servo motor 1332 can serve as an independent motion control system, thereby adding an additional degree of freedom to end effector 100.

In some embodiments, the wrist module of end effector 100 can be controlled using multiple linear actuators, such as the two linear actuators 1110 shown in FIG. 11. As shown in FIG. 13, each linear actuator 1342 in the wrist module of end effector 100 can communicate with a microcontroller 1348 in electrical system 1300 via a suitable communication protocol (e.g., transistor-transistor logic or TTL). As also shown in FIG. 13, electrical system 1300 can include a converter 1344 that allows linear actuators 1342 to communicate with microcontroller 1348. For example, converter 1344 can convert RS485 signals from linear actuator 1342 into transistor-transistor logic signals or any other suitable communication signals. Alternatively, converter 1344 can convert transistor-transistor logic signals from microcontroller 1348 to RS485 signals that control linear actuator 1342.

It should be noted that each microcontroller 1308, 1318, and 1348 and controller 1334 can communicate with a parent controller 1350 via a bus 1355. For example, as shown in FIG. 13, communication between microcontroller 1308, 1318, and 1348 and controller 1334 and parent controller 1350 can be handled by a two-way I²C protocol central bus.

It should also be noted that parent controller 1350 can be connected to any suitable computing device 1360 for controlling the motors, linear actuators, and other actuation mechanisms in end effector 100.

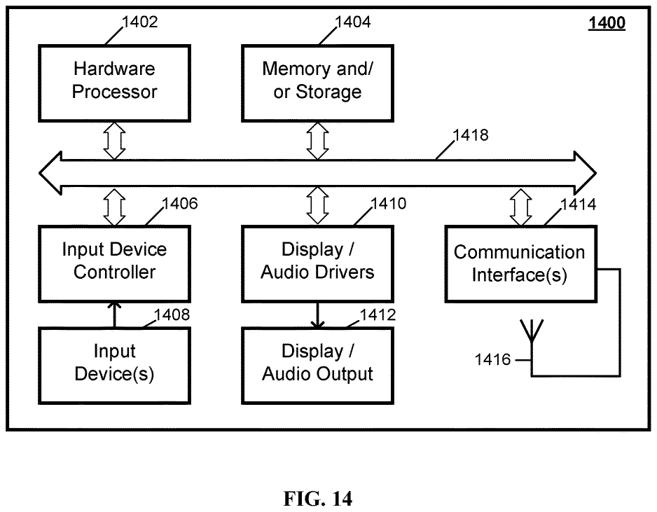

FIG. 14 is an example block diagram of hardware that can be used in a computing device 1360 of FIG. 13 in accordance with some embodiments of the disclosed subject matter.

Computing device 1360 can include any one or more computing devices suitable for controlling the motors, the linear actuators, and other actuation mechanisms in end effector 100, for determining finger position, thumb position, wrist position, and/or other signals, etc. For example, in some embodiments, computing device 1360 can determine a desired position of one or more fingers in the end effector and can break the desired position into a sequence of movements of one or more phalangeal joint assemblies and/or the carpometacarpal joint assembly in the fingers of end effector 100 and/or the wrist joint assembly in the wrist module of end effector 100. In continuing this example, computing device 1360 can transmit an instruction to the corresponding motors, the linear actuators, or other actuation mechanisms in end effector 100 to perform the sequence of movements of one or more phalangeal joint assemblies and/or the carpometacarpal joint assembly in the fingers of end effector 100 and/or the wrist joint assembly in the wrist module of end effector 100. In another example, in some embodiments, computing device 1360 can receive a request to perform a particular task (e.g., lift an object, grasp a delicate object, etc.) and, in response, can determine the sequence of movements by the fingers in the palm module and/or by the wrist in the wrist module to perform the particular task and can transmit instructions to one or more microcontrollers that control a corresponding motor, linear actuator, or other actuation mechanism in end effector 100.

In some embodiments, computing device 1360 can be implemented using any suitable hardware. For example, in some embodiments, computing device 1360 can be implemented using any suitable general-purpose computer or special-purpose computer. For example, a mobile phone may be implemented using a special-purpose computer. Any such general-purpose computer or special-purpose computer can include any suitable hardware. For example, as illustrated in example hardware 1400 of FIG. 14, such hardware can include hardware processor 1402, memory and/or storage 1404, an input device controller 1406, an input device 1408, display/audio drivers 1410, display and audio output circuitry 1412, communication interface(s) 1414, an antenna 1416, and a bus 1418.

Hardware processor 1402 can include any suitable hardware processor, such as a microprocessor, a micro-controller, digital signal processor(s), dedicated logic, and/or any other suitable circuitry for controlling the functioning of a general-purpose computer or a special-purpose computer in some embodiments. In some embodiments, hardware processor 1402 can be controlled by a server program stored in memory and/or storage of a server. In some embodiments, hardware processor 1402 can be controlled by a computer program stored in memory and/or storage 1404 of computing device 1360.

Memory and/or storage 1404 can be any suitable memory and/or storage for storing programs, data, and/or any other suitable information in some embodiments. For example, memory and/or storage 1404 can include random access memory, read-only memory, flash memory, hard disk storage, optical media, and/or any other suitable memory.

Input device controller 1406 can be any suitable circuitry for controlling and receiving input from one or more input devices 1408 in some embodiments. For example, input device controller 1406 can be circuitry for receiving input from a touchscreen, from a keyboard, from one or more buttons, from a voice recognition circuit, from a microphone, from a camera, from an optical sensor, from an accelerometer, from a temperature sensor, from a near field sensor, from a pressure sensor, from an encoder, and/or any other type of input device.

Display/audio drivers 1410 can be any suitable circuitry for controlling and driving output to one or more display/audio output devices 1412 in some embodiments. For example, display/audio drivers 1410 can be circuitry for driving a touchscreen, a flat-panel display, a cathode ray tube display, a projector, a speaker or speakers, and/or any other suitable display and/or presentation devices.

Communication interface(s) 1414 can be any suitable circuitry for interfacing with one or more communication networks. For example, interface(s) 1414 can include network interface card circuitry, wireless communication circuitry, and/or any other suitable type of communication network circuitry.

Antenna 1416 can be any suitable one or more antennas for wirelessly communicating with a communication network in some embodiments. In some embodiments, antenna 1416 can be omitted.

Bus 1418 can be any suitable mechanism for communicating between two or more components 1402, 1404, 1406, 1410, and 1414 in some embodiments.

Any other suitable components can be included in hardware 1400 in accordance with some embodiments.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory forms of magnetic media (such as hard disks, floppy disks, etc.), non-transitory forms of optical media (such as compact discs, digital video discs, Blu-ray discs, etc.), non-transitory forms of semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Exemplary Results with the End Effector

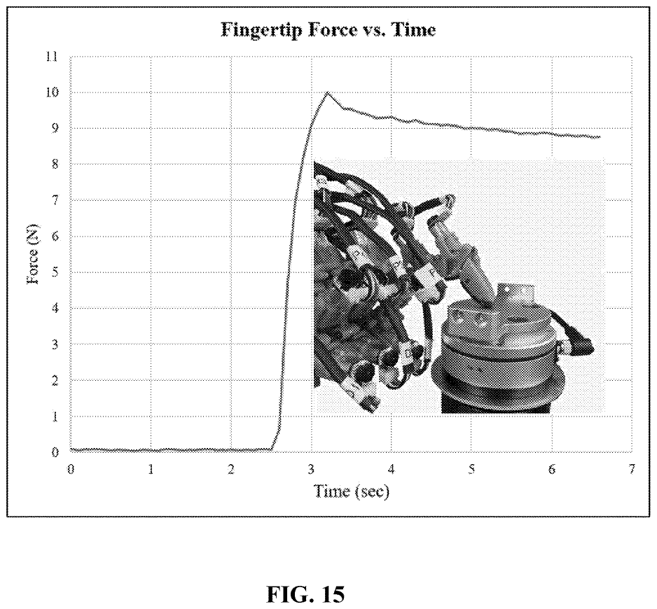

An illustrative example of active fingertip force of a finger and its corresponding phalangeal joints that are each being independently controlled by the linear actuation mechanism described above as a function of time is shown in FIG. 15.

Active finger force can generally refer to the force that end effector 100 can exert during active motor operation. To measure the active fingertip force, a force sensor was employed in an experimental setup where a finger of end effector 100 and its corresponding phalangeal joint assemblies that are each being independently controlled by the linear actuation mechanism described above were pressed against a load cell. As shown in FIG. 15, the finger of end effector 100 can provide and maintain a maximum active force of nearly 10 Newtons. With a consistent fingertip force profile across all five fingers, end effector 100 can actively grasp a payload of up to 5 kilograms or about 11 pounds.

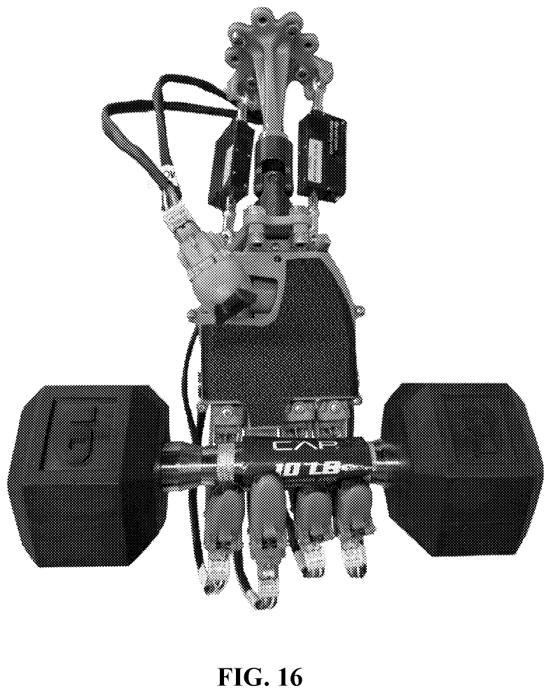

Passive force can generally refer to the maximum load that end effector 100 can hold statically in a fixed position without requiring continuous motor actuation. Using the self-locking mechanisms described above (e.g., in the linear actuation mechanism, in the thumb carpometacarpal actuation mechanism, in the abduction-adduction mechanism, etc.), the passive force capacity can ultimately be limited by the mechanical strength of end effector 100, which can be determined by design and/or material selection. To minimize stress concentration and maximize passive force handling, a finite element analysis (FEA) was performed on end effector 100 in which the design uses stereolithography (SLA) 3D printing to generate the components of end effector 100. It should be noted that, in some embodiments, replacing the components of end effector 100 with components of alternative materials (e.g., metal materials) can improve the passive load capacity. To avoid potential damage during passive load testing, a payload limit of 10 pounds was imposed as shown in FIG. 16. It should be noted that, from the finite element analysis, component failure of the components in end effector 100 would likely occur under significantly higher loading conditions, thereby suggesting that the actual passive load capacity is greater even using the current material in which stereolithography (SLA) 3D printed components were used in end effector 100.

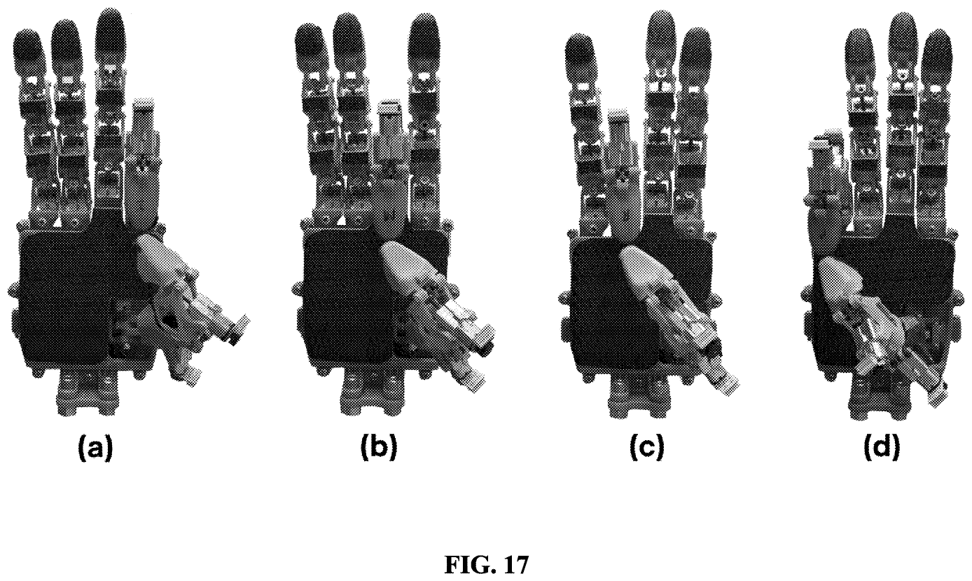

An illustrative example of thumb dexterity and opposability of the thumb in the palm module of end effector 100 is shown in FIG. 17. To evaluate thumb dexterity, thumb opposition of the thumb in the palm module of end effector 100 was tested, which is the ability of the thumb to touch the tips of each of the four fingers (D2 through D5) in the palm module of end effector 100. Each interaction in this test was analyzed in terms of 1) accuracy (e.g., whether the thumb in the palm module of end effector 100 can reach the precise fingertip location of one of four fingers (D2 through D5) in the palm module of end effector 100), 2) repeatability (e.g., the consistency of the thumb's position over multiple trials), and 3) contact success (e.g., complete fingertip-to-thumb contact without gaps). This test was carried out ten times for each finger (D2 through D5) in the palm module of end effector 100 in which the thumb in the palm module of end effector 100 demonstrated high positional accuracy, achieving a 100% contact success rate that was visually verified during thumb opposition tests. The thumb opposition for each finger (D2 through D5) in the palm module of end effector 100 is shown in FIG. 17 with (a) showing the contact success between the thumb and the index finger D2 in the palm module of end effector 100, (b) showing the contact success between the thumb and the middle finger D3 in the palm module of end effector 100, (c) showing the contact success between the thumb and the ring finger D4 in the palm module of end effector 100, and (d) showing the contact success between the thumb and the pinky finger D5 in the palm module of end effector 100.

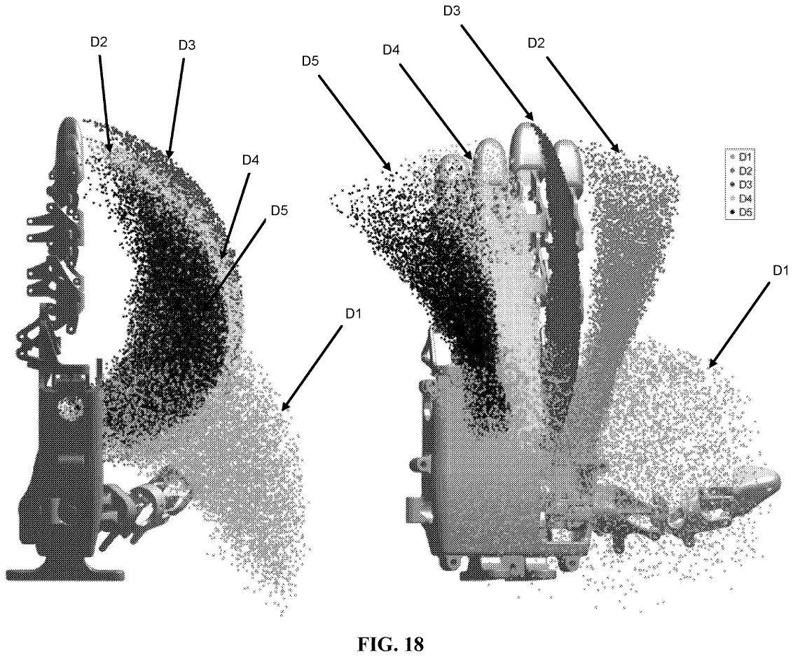

To further illustrate the manipulability of a robotic system using end effector 100, the workspaces of the fingers (D2 through D5) and the thumb D1 in the palm module of end effector 100 is shown with each fingertip as the end effector in FIG. 18. Note that FIG. 18 illustrates the regions of the workspace, confirming the opposability of the thumb in the palm module of end effector 100.

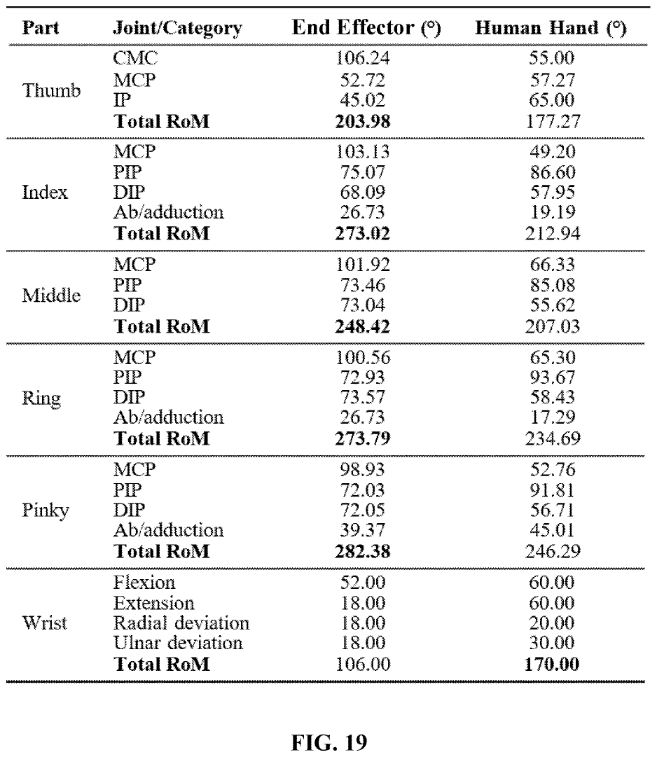

FIG. 19 shows an illustrative table that compares the range of motion between the joints in end effector 100 and the joints in a human hand. For example, each finger (D2 through D5) in the palm module of end effector 100 can include a phalangeal joint assembly (e.g., a distal interphalangeal joint) and a corresponding range of motion along with a total range of motion from the phalangeal joint assemblies included in each finger (D2 through D5) in the palm module of end effector 100. As shown in FIG. 19, the total range of motion for each finger in the palm module of end effector 100 is greater than the average range of motion of the human hand. End effector 100 achieves about an 11.2% higher range of motion compared to the corresponding human hand joint.

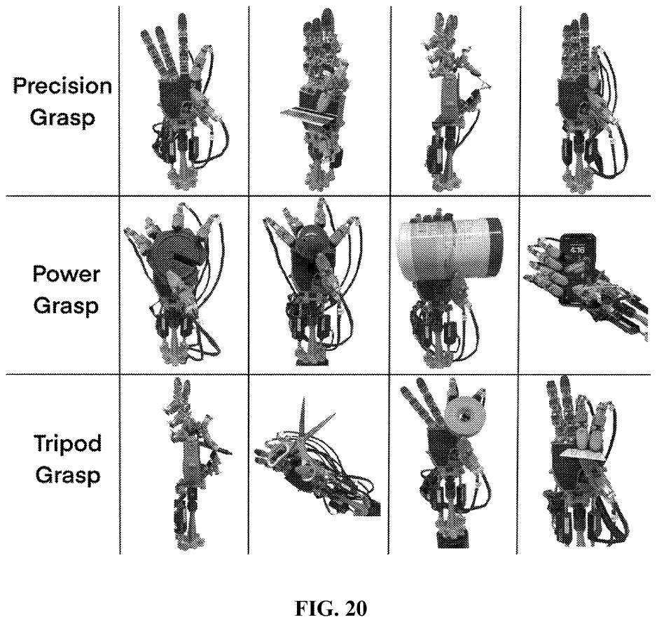

FIG. 20 shows illustrative examples of diverse and precise grasping tasks performed by end effector 100. As shown in FIG. 20, end effector 100 was instructed to perform various precision grasping tasks (e.g., grasp a hex nut, grasp a card, grasp a binder clip, and grasp a key), various power grasping tasks (e.g., grasp a 2 kilogram weight, grasp a rubber ball, grasp a cylindrical container of alcohol wipes, and grasp a cellular phone), and various tripod gripping tasks (e.g., grasp a marker, grasp a pair of scissors, grasp a roll of tape, and grasp a card with multiple fingers). It should be noted that the selected items were chosen to represent both industrial objects, such as tools, and everyday items, such as personal belongings and household objects, thereby ensuring that the evaluation reflects a broad spectrum of real-world use cases.

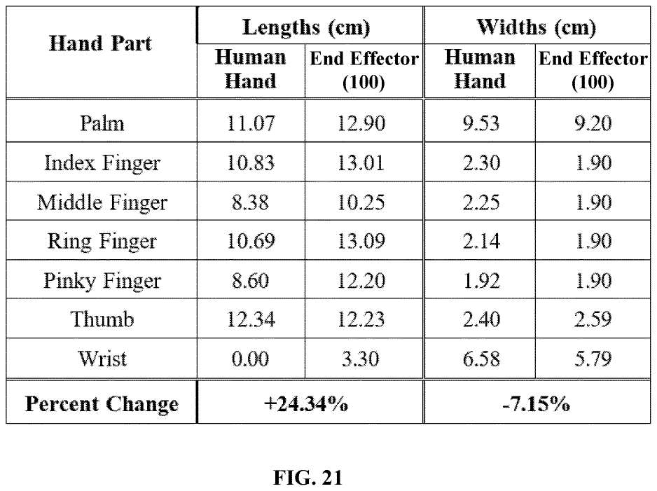

FIG. 21 shows an illustrative table that compares the dimensions of the fingers (D1 through D5) and the wrist of end effector 100 and the fingers and the wrist in a human hand. As shown, while the average length of the components in end effector 100 is generally greater than the average length of the components of the human hand, the average width of the components in end effector 100 is generally reduced by about 7.15% in comparison with the average width of the components of the human hand. Moreover, the palm-facing surface area of the human hand was estimated to be about 219.4 cm², while the palm-facing surface area of end effector 100 was determined to be about 242.5 cm², which makes end effector 100 about 10.6% larger than the human hand. For industrial applications, an increase in size by 10.6% bears relatively minor significance. Accordingly, this shows that the actuation mechanisms that control the joint assemblies of each finger can be integrated into the phalangeal cavities and the palm cavity of end effector 100 while maintaining an anthropomorphic design.

### Teleoperation of the End Effector

Generally speaking, teleoperation can be essential for tasks involving dexterous manipulation. This may be particularly relevant in learning-from-demonstration frameworks in which accurate reproduction of complex hand movements, such as those required in fine assembly tasks on production floors, is critical.

It should be noted that, while conventional approaches in visual hand tracking use virtual reality headsets and other vision-based approaches, the disclosed subject matter provides a hardware-based setup for high-precision teleoperation of end effector 100. More particularly, end effector 100 can be teleoperated using a hardware-based, inside-out tracking system in which the five finger assemblies of end effector 100 can be controlled by a motion-capture glove, the wrist assembly of end effector 100 can be controlled by an inertial measurement unit (that can be mounted or otherwise integrated with the motion-capture glove), and the base robot can be controlled by a motion tracker (that can be positioned on a forearm or other suitable portion of the wearer of the motion-capture glove). Such a system does not require external cameras or camera arrays, external lighthouses, or a fixed base station infrastructure.

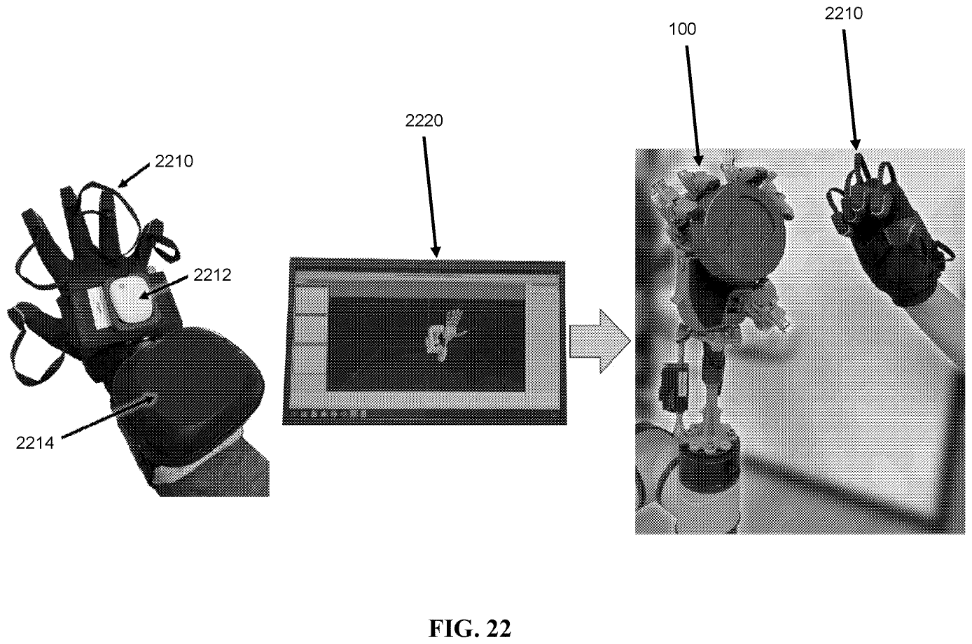

In some embodiments, the hardware-based setup for teleoperating end effector 100 can include a motion-capture glove that measures detailed finger motions. For example, FIG. 22 shows an illustrative example of teleoperation using an inside-out tracking system that includes a motion-capture glove, an inertial measurement unit, and one or more motion trackers, and the end effector configured in accordance with some embodiments of the disclosed subject matter. In particular, FIG. 22 shows that end effector 100 can be teleoperated using a motion capture technique with a motion-capture glove 2210. It should be noted that motion-capture glove 2210 can be a motion-capture glove that is configured to measure detailed finger motion, where the motion-capture glove has high spatial and temporal resolution, low-latency wireless communication capabilities, and compatibility with the multiple degree-of-freedom architectures of end effector 100. In continuing this example, the finger and/or other hand motion provided while a user is wearing motion-capture glove 2210 can be captured by an associated motion capture application 2220 (which implements a teleoperation package). The motion capture application 2220 can translate the motion information into corresponding motion information (e.g., desired angle information) for one or more phalangeal joint assemblies and/or the carpometacarpal joint assembly in the fingers of end effector 100. In a more particular example, the teleoperation package of motion capture application 2220 can capture the distal interphalangeal joint and fingertip Cartesian coordinates for each finger of motion-capture glove 2210 and can map the coordinates to phalangeal joint positions and fingertip positions of end effector 100 in a module for physics simulation, robotics, and deep reinforcement learning (e.g., Unified Robot Description Format control in a PyBullet environment). As described above, computing device 1360 or any other suitable computing device executing motion capture application 2220 can transmit an instruction to corresponding motors, linear actuators, or other actuation mechanisms in end effector 100 to perform the sequence of movements of one or more phalangeal joint assemblies and/or the carpometacarpal joint assembly in the fingers of end effector 100 to achieve the desired position (e.g., desired angles).

Additionally to finger teleoperation, in some embodiments, the wrist of end effector 100 can be teleoperated using an inertial measurement unit (IMU), which can be mounted on a portion of motion-capture glove 2210. For example, as shown in FIG. 22, inertial measurement unit 2212 can be mounted or otherwise positioned on the dorsal side of motion-capture glove 2210. It should be noted that inertial measurement unit 2212 can provide an orientation quaternion that is automatically zeroed at a neutral pose and that is converted into flexion-extension and/or radial-ulnar deviation commands, which can be applied to the corresponding wrist joints in a module for physics simulation, robotics, and deep reinforcement learning (e.g., Unified Robot Description Format control in a PyBullet environment) before broadcasting joint commands.

It should be noted that, as mentioned above, end effector 100 can be compatible with any suitable robotic arm. Thus, teleoperation can also include the post of the base robot or cobot carrying end effector 100 (such as an AUBO i5 6-axis manipulator). To do this, a motion tracker 2214 (such as one or more HTC VIVE ultimate trackers) can be worn on or about the forearm of the wearer of motion-capture glove 2210. This can, for example, allow motion tracker 2214 to estimate arm pose and drive the robot tool-center-point (TCP) motion in the simulation and control pipeline.

It should be noted that the hardware-based setup for teleoperating end effector 100 and the base robot or cobot that end effector 100 is connected to can be based on a hardware-based, inside-out teleoperation setup that does not require external cameras, lighthouses, or a fixed base station infrastructure, thereby enabling rapid deployment in laboratory and production floor environments.

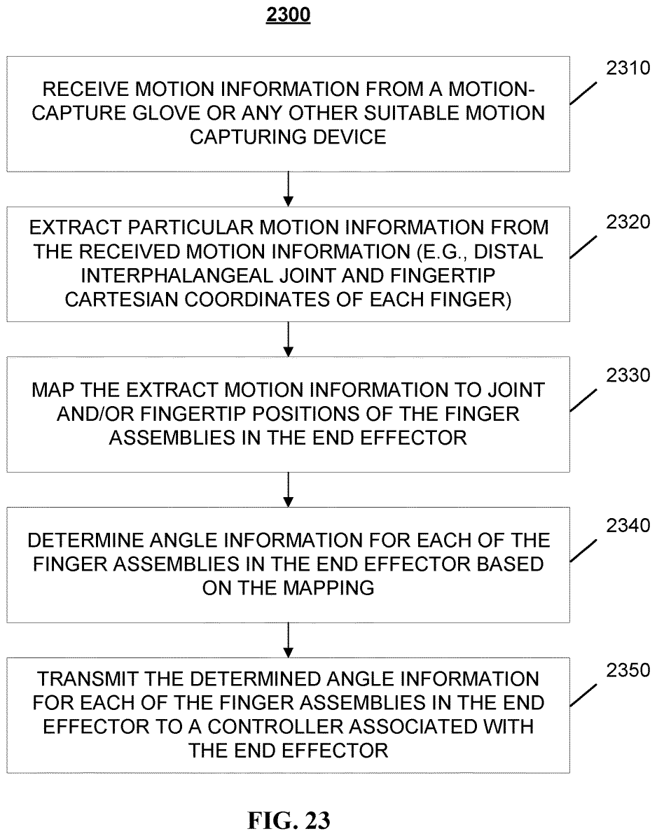

Turning to FIG. 23, an illustrative example of a process 2300 for translating movement information from the teleoperation setup that can include a motion-capture glove, an inertial measurement unit positioned on a wrist of a user wearing the motion-capture glove, and one or more motion trackers placed on a forearm of the user wearing the motion-capture glove to the end effector configured in accordance with some embodiments of the disclosed subject matter. In some embodiments, blocks of process 2300 can be performed on any suitable device, such as computing device 1360, a server, or any other suitable device. In some embodiments, blocks of process 2300 can be performed using multiple devices.

Process 2300 can begin, at 2310, by receiving motion information from a motion-capture glove or any other suitable motion-capturing device. For example, any suitable motion information can be received from a motion-capture glove (such as motion-capture glove 2210 in FIG. 22), an inertial measurement unit (such as inertial measurement unit 2212 mounted on the dorsal side of motion-capture glove 2210 in FIG. 22), and/or a motion tracker (such as motion tracker 2214 worn on a forearm of a wearer of motion-capture glove 2210 in FIG. 22).

In some embodiments, process 2300 can extract particular motion information from the received motion information at 2320. For example, a motion capture application executing on computing device 1360 can capture the distal interphalangeal joint and fingertip Cartesian coordinates for each finger in one or more movements by the motion-capture glove. In another example, the motion capture application executing on computing device 1360 can capture the distal interphalangeal joint and fingertip Cartesian coordinates for each finger in a final position of the motion-capture glove. In yet another example, the motion capture application executing on computing device 1360 can capture joint Cartesian coordinates for each joint in each finger and fingertip Cartesian coordinates for each finger in one or more movements by the motion-capture glove. In a further example, the motion capture application executing on computing device 1360 can receive orientation information corresponding to a wrist of a wearer of the motion-capture glove, such as an orientation quaternion, from the inertial measurement unit. In another further example, the motion capture application executing on computing device 1360 can receive arm pose information corresponding to a forearm of a wearer of the motion-capture glove.

In some embodiments, in response to extracting particular motion information, process 2300 can, at 2330, map the extracted motion information to joint and/or fingertip positions in the finger assemblies of end effector 100. It should be noted that mapping the distal interphalangeal joint and fingertip Cartesian coordinates for each finger in one or more movements by the motion-capture glove to joint and/or fingertip positions in the finger assemblies of end effector 100 can include scaling the Cartesian coordinates to match the dimensions of end effector 100 (e.g., where scaling is based on a difference in dimensions between the motion-capture glove and end effector 100, where scaling is based on a difference in dimensions between a human hand wearing the motion-capture glove and end effector 100, where scaling is based on a difference in dimensions between a finger of the motion-capture glove and a corresponding finger assembly of end effector 100, etc.). It should also be noted that mapping the distal interphalangeal joint and fingertip Cartesian coordinates for each finger in one or more movements by the motion-capture glove can include loading a universal robot description file or one or more libraries in a robot simulation platform.

Additionally, in some embodiments, process 2300 can map the extracted motion information to wrist movements in the wrist assemblies of end effector 100. For example, the received orientation information corresponding to a wrist of a wearer of the motion-capture glove, such as an orientation quaternion, from the inertial measurement unit can be converted into flexion-extension commands and/or radial-ulnar deviation commands for the wrist assemblies of end effector 100.

Additionally, in some embodiments, process 2300 can map the extracted motion information to cobot movements for a cobot that end effector 100 is connected to. For example, the received arm pose information corresponding to a forearm of a wearer of the motion-capture glove can be used to drive the robot tool-center-point motion of the cobot or base robot.

In some embodiments, process 2300 can, at 2340, determine angle information or other suitable position information for each of the finger assemblies in end effector 100 based on the mapping at 2330. For example, process 2300 can perform an inverse kinematics function (e.g., in a PyBullet environment) to calculate the desired angles (or other position information) for each joint in end effector 100. In continuing this example, based on the mapping of joint and/or fingertip position of each of the finger assemblies in end effector 100 from the extracted motion information, process 2300 can determine a desired angle for each joint assembly in end effector 100 (e.g., one or more phalangeal joint assemblies and/or the carpometacarpal joint assembly in end effector 100).

In some embodiments, in response to determining the angle information or other suitable position information for each of the finger assemblies in end effector 100, the flexion-extension commands and/or radial-ulnar deviation commands for the wrist assemblies of end effector 100, and/or the robot tool-center-point motion information derived from arm pose information, process 2300 can, at 2350, transmit the desired angle information, the flexion-extension commands and/or radial-ulnar deviation commands, and/or the robot tool-center point motion information for each joint assembly to a parent controller (such as parent controller 1350 in FIG. 13) or any suitable microcontrollers for controlling the corresponding motors, linear actuators, or other actuation mechanisms in end effector 100. For example, a motion capture application executing on computing device 1360 can transmit ROS2 messages or any other suitable message to parent controller 1350 (e.g., a Raspberry Pi Pico microcontroller), where the ROS2 messages can include, among other things, the desired angle information for each joint assembly. Parent controller 1350 can, in turn, instruct individual microcontrollers to control the corresponding motors, linear actuators, or other actuation mechanisms in end effector 100 to achieve the desired angle. For example, parent controller 1350 can determine which motors, linear actuators, and/or other actuation mechanisms need to be controller to achieve the determined angle information for each of the finger assemblies in end effector 100. In another example, the motion capture application executing on computing device 1360 can transmit ROS2 messages or any other suitable message to parent controller 1350, where the ROS2 messages can include, among other things, the flexion-extension commands and/or radial-ulnar deviation commands for the wrist assemblies of end effector 100 and robot tool-center point motion information for a cobot or base robot that end effector 100 is connected to.

In some embodiments, at least some of the above described blocks of the process of FIG. 23 can be executed or performed in any order or sequence not limited to the order and sequence shown in and described in connection with the figures. Also, some of the above blocks of FIG. 23 can be executed or performed substantially simultaneously where appropriate or in parallel to reduce latency and processing times. Additionally or alternatively, some of the above described blocks of the process of FIG. 23 can be omitted.

Accordingly, an end effector having multiple fingers for robotic systems is provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A robotic end effector apparatus comprising:
a palm assembly having five fingers, wherein each finger has a plurality of phalangeal joint assemblies and a plurality of phalangeal cavities, wherein each phalangeal joint assembly is independently controlled using a linear actuator assembly that is actuated by a motor, and wherein the motor in the linear actuator assembly for each phalangeal joint assembly is positioned within one of the plurality of phalangeal cavities.

2. The robotic end effector apparatus of claim 1, wherein the linear actuator assembly includes a leadscrew nut that traverses a leadscrew actuated by the motor, wherein the leadscrew is connected to the motor at an end of the leadscrew and wherein the leadscrew nut is connected to the leadscrew at an opposing end of the leadscrew.

3. The robotic end effector apparatus of claim 2, wherein at least one of the five fingers includes three phalangeal joint assemblies and wherein each of the three phalangeal joint assemblies is one of a distal interphalangeal joint assembly, a proximal interphalangeal joint assembly, and a metacarpophalangeal joint assembly.

4. The robotic end effector apparatus of claim 3, wherein a first length of the leadscrew in the linear actuator assembly corresponding to at least one of the distal interphalangeal joint assembly and the proximal interphalangeal joint assembly is different than a second length of the leadscrew in the linear actuator assembly corresponding to the metacarpophalangeal joint assembly.

5. The robotic end effector apparatus of claim 2, wherein the leadscrew nut connects the linear actuator assembly corresponding to a phalangeal joint assembly to a finger phalange, wherein rotation of the leadscrew by the motor in the linear actuator assembly causes an axial force on the leadscrew nut, and wherein the axial force on the leadscrew nut generates a torque around the phalangeal joint assembly.

6. The robotic end effector apparatus of claim 2, wherein a friction angle between a resultant friction force and a normal force between the leadscrew and the leadscrew nut in the linear actuator assembly is configured to be greater than a lead angle of the leadscrew in the linear actuator assembly.

7. The robotic end effector apparatus of claim 2, wherein at least one of the five fingers includes two phalangeal joint assemblies and wherein each of the two phalangeal joint assemblies is one of an interphalangeal joint assembly and a metacarpophalangeal joint assembly.

8. The robotic end effector apparatus of claim 7, wherein at least one of the five fingers includes a thumb, wherein the thumb includes the linear actuator assembly for each of the interphalangeal joint assembly and the metacarpophalangeal joint assembly, and wherein the thumb includes a carpometacarpal joint assembly that comprises:
a thumb motor positioned within a palm cavity of the palm assembly; and
a driver worm that is connected to the thumb motor and a worm wheel, wherein rotation of the driver worm by the thumb motor causes the worm wheel to rotate and actuate the carpometacarpal joint assembly.

9. The robotic end effector apparatus of claim 8, wherein the carpometacarpal joint assembly further comprises a ball bearing that secures the driver worm to an inner wall portion of the palm cavity.

10. The robotic end effector apparatus of claim 7, wherein at least one of the five fingers includes a thumb, wherein the thumb includes the linear actuator assembly for each of the interphalangeal joint assembly and the metacarpophalangeal joint assembly, and wherein the thumb includes a carpometacarpal joint assembly that comprises:
a flexion-extension motor positioned within a palm cavity of the palm assembly; and
a driver worm that is connected to the flexion-extension motor and a worm wheel, wherein rotation of the driver worm by the thumb motor causes the worm wheel to rotate and actuate the carpometacarpal joint assembly to provide movement toward and away from the palm assembly.

11. The robotic end effector apparatus of claim 7, wherein at least one of the five fingers includes a thumb, wherein the thumb includes the linear actuator assembly for each of the interphalangeal joint assembly and the metacarpophalangeal joint assembly, and wherein the thumb includes a carpometacarpal joint assembly that comprises:
an abduction-adduction motor positioned within a palm cavity of the palm assembly that drives one or more spur gears, wherein rotation of the one or more spur gears actuates the carpometacarpal joint assembly to provide motion out of a hand plane.

12. The robotic end effector apparatus of claim 1, further comprising:
a servo motor that is connected to a pinion gear;
a hybrid transmission shaft that includes a bevel gear portion and a plurality of worm portions, wherein the pinion gear is configured to interact with the bevel gear portion on the hybrid transmission shaft; and
a worm gear positioned at a base of a finger, wherein the worm gear is configured to interact with one of the plurality of worm portions on the hybrid transmission shaft.

13. The robotic end effector apparatus of claim 12, wherein a first portion of the plurality of worm portions on the hybrid transmission shaft has a different orientation than a second portion of the plurality of worm portions on the hybrid transmission shaft.

14. The robotic end effector apparatus of claim 12, wherein the servo motor is configured to drive the plurality of worm portions on the hybrid transmission shaft, and wherein the plurality of worm portions on the hybrid transmission shaft interact with a plurality of worm gears located at the base of a subset of the five fingers in the palm assembly.

15. The robotic end effector apparatus of claim 1, further comprising a plurality of servo motors that are each connected to a worm gear located at the base of each of the five fingers in the palm assembly.

16. The robotic end effector apparatus of claim 1, further comprising:
a plurality of servo motors that are each connected to a pinion gear;
a plurality of hybrid transmission shafts that each includes a bevel gear portion and a worm portion, wherein the pinion gear connected to one of the plurality of servo motors is configured to interact with the bevel gear portion on one of the plurality of hybrid transmission shafts; and
a worm gear positioned at a base of a finger is independently controlled by one of the plurality of servo motors, wherein the worm gear is configured to interact with the worm portion on one of the plurality of hybrid transmission shafts.

17. The robotic end effector apparatus of claim 1, further comprising a wrist assembly having a lower wrist platform that is connected to a robotic system and an upper wrist platform that is connected to the palm assembly.

18. The robotic end effector apparatus of claim 17, wherein the wrist assembly comprises a plurality of linear actuators that are each connected to the lower wrist platform and the upper wrist platform.

19. The robotic end effector apparatus of claim 18, wherein each of the plurality of linear actuators is connected to a plurality of connection points on one of the lower wrist platform and the upper wrist platform using a plurality of spherical joints.

20. The robotic end effector apparatus of claim 18, wherein the wrist assembly comprises a ninety degree universal joint that links the lower wrist platform and the upper wrist platform and that is positioned between the plurality of linear actuators.

21. The robotic end effector apparatus of claim 1, further comprising:
a plurality of motors that control a plurality of linear actuator assemblies that are each associated with one of the plurality of phalangeal joint assemblies;
a plurality of motor controllers that each transmit power signals from a power supply to a first subset of the plurality of motors and receive encoder signals from the first subset of the plurality of motors; and
a microcontroller that transmits instructions to and receives the encoder signals from a second subset of the plurality of motors.

22. The robotic end effector apparatus of claim 19, wherein the microcontroller receives instructions from at least one of a parent controller and a computing device.

23. A robotic end effector apparatus comprising:
a palm assembly having five fingers, wherein each finger has a plurality of phalangeal joint assemblies, wherein each phalangeal joint assembly is independently controlled using a linear actuator assembly that is actuated by a motor, and wherein each phalangeal joint assembly is configured to be self-locking by selecting a friction angle between a resultant friction force and a normal force between an output shaft of the motor in the linear actuator assembly and a component in the linear actuator assembly that is positioned at an end of the output shaft to be greater than a lead angle of the output shaft of the motor in the linear actuator assembly.

24. A robotic end effector apparatus comprising:
a palm assembly having five fingers, wherein each finger has a plurality of phalangeal joint assemblies, and wherein each phalangeal joint assembly is independently controlled using a linear actuator assembly that is actuated by a motor; and
a wrist assembly that includes a lower wrist platform that is connected to a robotic system, an upper wrist platform that is connected to the palm assembly, a plurality of linear actuators that are each connected to the lower wrist platform and the upper wrist platform, and a universal wrist joint that links the lower wrist platform and the upper wrist platform and that is positioned between the plurality of linear actuators.

25. The robot end effector apparatus of claim 24, further comprising a teleoperation system that includes a motion-capture glove worn by a user, an inertial measurement unit, and one or more inside-out positional tracking devices, wherein first motions captured by the motion-capture glove are translated to teleoperate each phalangeal joint assembly in the palm assembly, wherein second motions captured by the inertial measurement unit are translated to teleoperate the wrist assembly, and wherein third motions captured by the one or more inside-out positional tracking devices are translated to teleoperate the robotic system.
